(19) United States
(12) Patent Application Publication
(10) Pub. No.: US 2026/0333454 A1
(43) Pub. Date: Oct. 22, 2026

(54) RESOURCE DETERMINATION FOR A RANDOM ACCESS CHANNEL PROCEDURE

(71) Applicant: Lenovo (United States) Inc., Morrisville, NC (US)

(72) Inventors: Karthikeyan Ganesan, Nauheim (DE); Ali Ramadan Ali, Kraiburg am Inn (DE); Ravi Kuchibhotla, Chicago, IL (US)

(73) Assignee: Lenovo (United States) Inc., Morrisville, NC (US)

(21) Appl. No.: 19/300,563

(22) Filed: Aug. 14, 2025

(51) Int. Cl. H04W 74/0833; H04B 17/318; H04W 72/044

(52) U.S. Cl. CPC H04W 74/0833; H04B 17/328; H04W 72/044

(57) ABSTRACT

Various aspects of the present disclosure relate to resource determination for a random access channel (RACH) procedure. A user equipment (UE) may transmit a first message of a RACH procedure to a network equipment (NE). The UE may receive a second message of the RACH procedure in response to the first message, such as a random access response (RAR). The second message may not include uplink grant information for transmission of a third message. The UE and/or the NE may determine a time-frequency resource for the transmission of the third message of the RACH procedure based on at least one of a first association between the time-frequency resource and the second message or a second association between the time-frequency resource and the first message. The UE may transmit the third message of the RACH procedure utilizing the time-frequency resource.

### TECHNICAL FIELD

The present disclosure relates to wireless communications, and more specifically to determining resources for transmitting and receiving messages.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to transmit a first message of a random access channel (RACH) procedure, receive, based on the first message, a second message of the RACH procedure, determine a time-frequency resource for transmission of a third message of the RACH procedure based on at least one of a first association between the time-frequency resource and the second message or a second association between the time-frequency resource and the first message, and transmit the third message of the RACH procedure based on the time-frequency resource.

A processor (e.g., a standalone processor chipset, or a component of a UE) for wireless communication is described. The processor may be configured to, capable of, or operable to perform one or more operations as described herein. For example, the processor may be configured to, capable of, or operable to transmit a first message of a RACH procedure, receive, based on the first message, a second message of the RACH procedure, determine a time-frequency resource for transmission of a third message of the RACH procedure based on at least one of a first association between the time-frequency resource and the second message or a second association between the time-frequency resource and the first message, and transmit the third message of the RACH procedure based on the time-frequency resource.

A method performed or performable by a UE for wireless communication is described. The method may include transmitting a first message of a RACH procedure, receiving, based on the first message, a second message of the RACH procedure, determining a time-frequency resource for transmission of a third message of the RACH procedure based on at least one of a first association between the time-frequency resource and the second message or a second association between the time-frequency resource and the first message, and transmitting the third message of the RACH procedure based on the time-frequency resource.

In some implementations of the UE, the processor, and the method described herein, the UE, the processor, and the method may further be configured to, capable of, or operable to receive a system information block (SIB) that indicates one or more time-frequency resources including the time-frequency resource. In some implementations, the second message indicates the first association based on an index corresponding to the time-frequency resource from the one or more time-frequency resources, and reception of the second message activates the time-frequency resource. In some implementations, the second message fails to indicate an index associated with the time-frequency resource from the one or more time-frequency resources, and the UE, the processor, and the method may further be configured to, capable of, or operable to select the time-frequency resource from the one or more time-frequency resources within a time window based on the first association. In some implementations, the time window is based on a device type associated with the UE. In some implementations, the UE, the processor, and the method may further be configured to, capable of, or operable to receive a SIB that indicates a first synchronization signal block (SSB)-reference signal received power (RSRP), receive an SSB associated with a second SSB-RSRP, and select a numerical quantity of repetitions associated with the third message based on comparing a difference between the first SSB-RSRP and the second SSB-RSRP to one or more SSB-RSRP threshold values.

In some implementations, the first association is between one or more RACH occasions (ROs) and one or more time-frequency resources, the one or more ROs are associated with a set of RACH preambles including a RACH preamble corresponding to the first message, and respective time-frequency resources of the one or more time-frequency resources include one or more transmission occasions (TOs) for the transmission of the third message within a time period. In some implementations, the UE, the processor, and the method may further be configured to, capable of, or operable to receive semi-static signaling that indicates the one or more time-frequency resources, and the first association is based on an ascending order of first indices associated with the one or more time-frequency resources and second indices associated with the one or more ROs. In some implementations, the first association is based on an ascending order of respective time periods associated with the one or more time-frequency resources and indices associated with respective RACH preambles of the set of RACH preambles, a duration of the respective time periods is based on a time window, and the time window is based on a device type associated with the UE. In some implementations, the first association is based on an ascending order of first indices associated with the one or more time-frequency resources and second indices associated with respective RACH preambles of the set of RACH preambles. In some implementations, the first association is based on an ascending order of indices associated with the one or more ROs and respective time periods associated with the one or more time-frequency resources. In some implementations, the set of RACH preambles are associated with respective orthogonal cover code (OCC) sequence indices, and the first association is based on an ascending order of the respective OCC sequence indices and indices associated with respective RACH preambles of the set of RACH preambles.

In some implementations, the UE, the processor, and the method may further be configured to, capable of, or operable to receive signaling that indicates an additional time-frequency resource associated with the third message based on a collision between the third message and an additional message, and transmit the third message of the RACH procedure based on the additional time-frequency resource. In some implementations, the second message includes one or more of a random access preamble identifier (RAPID) associated with the first message, a timing advance, a temporary cell-radio network temporary identifier (C-RNTI), or an index associated with the time-frequency resource. In some implementations, the UE, the processor, and the method may further be configured to, capable of, or operable to determine a third association between one or more ROs and one or more monitoring occasions associated with the second message. In some implementations, the time-frequency resource includes a configured grant (CG) resource.

An NE (e.g., a base station, gNB) for wireless communication is described. The NE may be configured to, capable of, or operable to perform one or more operations as described herein. For example, the NE may be configured to, capable of, or operable to receive a first message of a RACH procedure, transmit, based on the first message, a second message of the RACH procedure, determine a time-frequency resource for reception of a third message of the RACH procedure based on at least one of a first association between the time-frequency resource and the second message or a second association between the time-frequency resource and the first message, and receive the third message of the RACH procedure based on the time-frequency resource.

A processor (e.g., a standalone processor chipset, or a component of an NE) for wireless communication is described. The processor may be configured to, capable of, or operable to perform one or more operations as described herein. For example, the processor may be configured to, capable of, or operable to receive a first message of a RACH procedure, transmit, based on the first message, a second message of the RACH procedure, determine a time-frequency resource for reception of a third message of the RACH procedure based on at least one of a first association between the time-frequency resource and the second message or a second association between the time-frequency resource and the first message, and receive the third message of the RACH procedure based on the time-frequency resource.

A method performed or performable by an NE (e.g., a base station) for wireless communication is described. The method may include receiving a first message of a RACH procedure, transmitting, based on the first message, a second message of the RACH procedure, determining a time-frequency resource for reception of a third message of the RACH procedure based on at least one of a first association between the time-frequency resource and the second message or a second association between the time-frequency resource and the first message, and receiving the third message of the RACH procedure based on the time-frequency resource.

In some implementations of the NE, the processor, and the method described herein, the NE, the processor, and the method may further be configured to, capable of, or operable to transmit a SIB that indicates one or more time-frequency resources including the time-frequency resource, and the second message indicates the first association based on an index corresponding to the time-frequency resource from the one or more time-frequency resources. In some implementations, the NE, the processor, and the method may further be configured to, capable of, or operable to transmit a SIB that indicates a first SSB-RSRP, and transmit an SSB associated with a second SSB-RSRP, where a numerical quantity of repetitions associated with the third message is based on comparing a difference between the first SSB-RSRP and the second SSB-RSRP to one or more SSB-RSRP threshold values.

In some implementations, the first association is between one or more ROs and one or more time-frequency resources, the one or more ROs are associated with a set of RACH preambles including a RACH preamble corresponding to the first message, and respective time-frequency resources of the one or more time-frequency resources include one or more TOs for transmission of the third message within a time period. In some implementations, the NE, the processor, and the method may further be configured to, capable of, or operable to transmit semi-static signaling that indicates the one or more time-frequency resources, and the first association is based on an ascending order of first indices associated with the one or more time-frequency resources and second indices associated with the one or more ROs. In some implementations, the first association is based on an ascending order of respective time periods associated with the one or more time-frequency resources and indices associated with respective RACH preambles of the set of RACH preambles, a duration of the respective time periods is based on a time window, and the time window is based on a device type associated with a UE. In some implementations, the first association is based on an ascending order of first indices associated with the one or more time-frequency resources and second indices associated with respective RACH preambles of the set of RACH preambles. In some implementations, the first association is based on an ascending order of indices associated with the one or more ROs and respective time periods associated with the one or more time-frequency resources. In some implementations, the set of RACH preambles are associated with respective OCC sequence indices, and the first association is based on an ascending order of the respective OCC sequence indices and indices associated with respective RACH preambles of the set of RACH preambles.

In some implementations, the NE, the processor, and the method may further be configured to, capable of, or operable to determine a collision between the third message and an additional message based on one or more of a numerical quantity of random access preambles received, RAPIDs associated with the random access preambles, or cyclic demodulation reference signal DMRS configurations associated with an uplink shared channel corresponding to the third message, transmit signaling that indicates an additional time-frequency resource associated with the third message based on the collision between the third message and the additional message, and receive the third message of the RACH procedure based on the additional time-frequency resource. In some implementations, the second message includes one or more of a RAPID associated with the first message, a timing advance, a temporary C-RNTI, or an index associated with the time-frequency resource. In some implementations, the time-frequency resource includes a CG resource.

### BRIEF DESCRIPTION OF THE DRAWINGS

FIG. 1 illustrates an example of a wireless communications system in accordance with aspects of the present disclosure.

FIGS. 2 through 5 illustrate examples of resource diagrams, in accordance with aspects of the present disclosure.

FIG. 6 illustrates an example of a signaling diagram, in accordance with aspects of the present disclosure.

FIGS. 7 through 10 illustrate examples of resource diagrams, in accordance with aspects of the present disclosure.

FIG. 11 illustrates an example of a resource association diagram, in accordance with aspects of the present disclosure.

FIG. 12 illustrates an example of a signaling diagram, in accordance with aspects of the present disclosure.

FIG. 13 illustrates an example of a UE in accordance with aspects of the present disclosure.

FIG. 14 illustrates an example of a processor in accordance with aspects of the present disclosure.

FIG. 15 illustrates an example of an NE in accordance with aspects of the present disclosure.

FIG. 16 illustrates a flowchart of a method performed by a UE in accordance with aspects of the present disclosure.

FIG. 17 illustrates a flowchart of a method performed by an NE in accordance with aspects of the present disclosure.

### DETAILED DESCRIPTION

A wireless communications system can include various devices, such as UEs and NEs, which may support wireless communication (e.g., reception and/or transmission of wireless communication) using time-frequency resources. For example, a UE may initiate a RACH procedure to establish an initial connection with an NE or to request uplink resources for uplink communication from the UE to the NE. The RACH procedure may include exchanging multiple messages, such as four messages in a four-step RACH procedure. For the four-step RACH procedure, the UE can transmit one or more random access preambles in a first message, referred to as Msg1. The UE can receive one or more random access responses (RARs) in a second message, referred to as Msg2. The RARs may include uplink grant fields with values that indicate time-frequency resources for the UE to use to transmit a third message of the RACH procedure, referred to as Msg3. The UE can transmit a scheduled transmission in the Msg3 utilizing the time-frequency resources indicated in the RAR. The UE can receive a contention resolution message in a fourth message, referred to as Msg4.

However, a wireless communication system may include various device types and a relatively large numerical quantity of devices (e.g., greater than a threshold numerical quantity of devices), leading to inefficient resource utilization, increased collisions, and increased signaling overhead and latency for RACH procedures that rely on the RAR to allocate time-frequency resources for the Msg3. For example, including uplink grant fields in the RAR messages consumes a significant portion of available bits in the RAR (e.g., greater than a threshold numerical quantity of bits in the RAR), which reduces a numerical quantity of devices (e.g., UEs) that can be served concurrently and increases signaling overhead. If multiple UEs receive RARs with overlapping time-frequency resource allocations in the uplink grant fields, then one or more corresponding Msg3 transmissions may collide (e.g., interfere). The collisions lead to retransmissions, which leads to inefficient resource utilization and increases signaling overhead and latency. Further, the uplink grant fields in the RARs may have a fixed size, which may not provide sufficient flexibility for various transmission patterns, power consumption criterion, and network coverage criterion of different device types or categories.

As described herein, to improve resource utilization, reduce collisions, and reduce signaling overhead and latency for RACH procedures, a UE may determine one or more time-frequency resources for transmitting Msg3 implicitly according to defined associations between the time-frequency resources and one or more previous messages in the RACH procedure (e.g., Msg 1 and/or Msg2). For example, the UE may transmit a Msg1 to an NE including a random access preamble and may receive a Msg2 in response that includes a RAR without a time-frequency resource allocation. The UE may determine one or more time-frequency resources for a Msg3 transmission by utilizing at least one of an association between the time-frequency resources and Msg2 or an association between the time-frequency resources and the Msg1. In some cases, the UE may determine the associations utilizing various parameters and/or information, including, but not limited to, time-frequency resource indices, time periods, device type, and OCC sequence indices. The UE may transmit the Msg3 transmission utilizing the time-frequency resources.

By performing the described techniques, one or more devices (e.g., UEs and NEs) in a wireless communications system can determine time-frequency resources for a Msg3 of a RACH procedure according to defined associations (e.g., rules, configurations, mappings) rather than uplink grant fields in a RAR. The UEs and/or NEs determining the time-frequency resources according to the defined associations improves resource utilization, reduces signaling overhead and latency, and reduces Msg3 transmission collisions. Utilizing the associations also provides for a wireless communications system to implement the RACH procedure for various device types.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

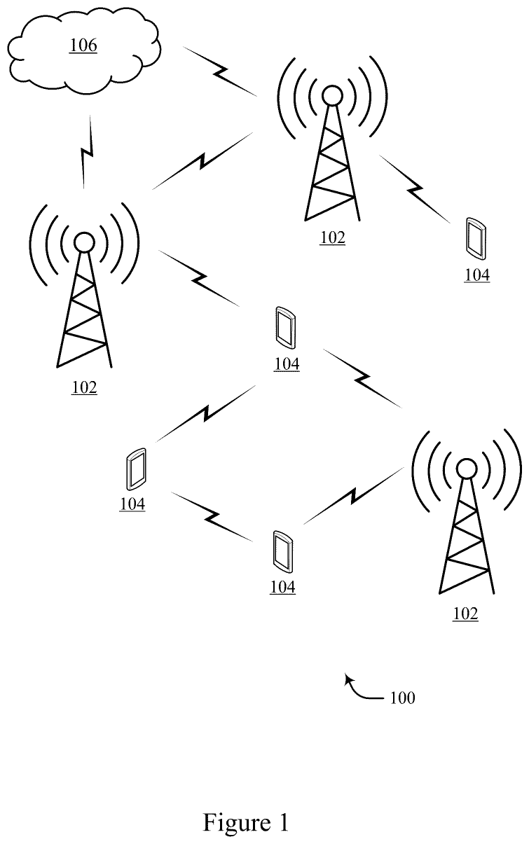

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may utilize resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

The wireless communications system 100 may support one or more numerologies, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1, μ=2,μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may implement a unified radio access technology for terrestrial networks and NTNs. The unified radio access technology may also support various device types, such as various types of UEs 104 and NEs 102 in a wireless communications system 100 (e.g., a cellular wireless communications system, a Wi-Fi communications system, or any other type of wireless communications system). The device types may include mobile broadband (MBB) devices that utilize relatively high data rates (e.g., greater than a threshold value) for applications, such as video streaming and augmented reality. Additionally, or alternatively, the device types may include massive machine-type communications (mMTC) devices with relatively low power consumption (e.g., less than a threshold value) and extended coverage for sensor networks and industrial monitoring. Additionally, or alternatively, the device types may include Internet of Things (IoT) devices that connect various components in the wireless communications system 100, such as for smart home applications, devices within cities, and infrastructure applications. The unified radio access technology accommodates the diverse criterion of the various device categories and types, while supporting connectivity for a relatively large numerical quantity of devices (e.g., mass connectivity, greater than a threshold numerical quantity of devices).

In the wireless communications system 100, UEs 104 may initiate RACH procedures to establish initial connections with NEs 102 and/or to request uplink resources for data transmission. The wireless communications system 100 may support different types of RACH procedures, including four-step RACH procedures and two-step RACH procedures. A four-step RACH procedure may include a UE 104 transmitting a random access preamble in a first message (e.g., Msg1), receiving a RAR in a second message (e.g., Msg2), transmitting a scheduled transmission in a third message (e.g., Msg3), and receiving a contention resolution message in a fourth message (e.g., Msg4). A UE 104 and/or an NE 102 may use a four-step RACH procedure if the UE 104 is performing an initial network access, a handover procedure, or an uplink synchronization after a duration or time period of inactivity. A two-step RACH procedure may include a UE 104 transmitting both a random access preamble and uplink data in a first message (e.g., MsgA), and receiving a response message that combines a RAR and contention resolution functions in a second message (e.g., MsgB). A UE 104 and/or an NE 102 may use a two-step RACH procedure if the UE 104 has a relatively small amount of data to transmit (e.g., less than a threshold value), such as for IoT devices, periodic reporting, or if network conditions provide for reduced signaling overhead. Although various operations and functions in FIGS. 1 through 17 are described in the context of a four-step RACH procedure, a UE 104 and/or an NE 102 may implement any type of RACH procedure to perform the various operations and functions in FIGS. 1 through 17.

For a four-step RACH procedure, a UE 104 may transmit a Msg1 to an NE 102 including a randomly selected preamble sequence from a configured set of preamble sequences. A UE 104 may select the preamble according to various factors, such as path loss measurements, device type, or access criterion. The preamble transmission in Msg1 may serve multiple purposes, including initial timing synchronization with the NE 102, indication of a presence of the UE 104 and access attempt, and/or conveying information about a capability of the UE 104 or service criterion of the UE 104 through the preamble sequence. Upon successful detection of the preamble, the NE 102 may respond with Msg2, which may include an RAR with a RAPID field to identify a preamble that is being responded to, a timing advance command to adjust a transmission timing of a UE 104 for uplink synchronization, a temporary C-RNTI for subsequent communications, and an uplink grant specifying time-frequency resources for a Msg3 transmission. In some cases, the NE 102 may transmit the Msg2 in a RAR window following the Msg1 transmission. The NE 102 may include multiple RARs in a single medium access control (MAC) PDU to respond to multiple UEs 104 concurrently. A MAC PDU is a data structure that includes MAC layer information and payload data formatted for transmission over a wireless communication link. The UE 104 may transmit Msg3 using one or more resources that the NE 102 allocated in the uplink grant from Msg2, where Msg3 may include identity information of the UE 104, connection request details, or other control signaling depending on the purpose of the RACH procedure. For initial access, the Msg3 may include a connection setup request with UE capabilities and authentication information. For scheduling requests or beam failure recovery, the Msg3 may include different types of control information. The NE 102 may transmit Msg4 as a contention resolution message to confirm successful completion of the RACH procedure, where Msg4 may include an identity of the UE 104 to resolve any potential contention from multiple UEs that may have used the same preamble, assignment of a permanent C-RNTI for ongoing communications, and acknowledgment of the information that the NE 102 received in the Msg3.

In some examples, a MAC PDU structure in a RAR includes multiple subPDUs. A subPDU may be a component within a MAC PDU that includes defined control information or data elements, such as timing advance commands, uplink grants, or temporary identifiers. Each subPDU may include eight bytes, where a byte includes eight bits. The eight bytes include a RAPID of a corresponding received Msg1, which acknowledges the reception of Msg1, and also includes an uplink grant with time-frequency resource information for Msg 3 transmission (e.g., 27 bits). In some cases, an RAR MAC PDU is a combined report acknowledging multiple Msg1 preamble transmissions. After transmission of a Msg1 preamble, a UE 104 may wait for an RAR from an NE 102 within an RAR window. Failure to receive a RAR triggers retransmission of preambles. However, uplink grant signaling in Msg2 leads to increased signaling overhead, with each RAR subPDU utilizing 27 bits for uplink grant information. Including the uplink grant signaling in Msg2reduces an overall capacity of the RAR MAC PDU and reduces the number of UEs that can be served concurrently. Additionally, or alternatively, explicitly indicating the uplink grant information in the RAR MAC PDU lacks the flexibility to efficiently handle diverse device types with varying traffic patterns and criterion, such as IoT devices with smaller, more frequent transmission opportunities compared to MBB devices with relatively larger resource blocks (RBs) for transmissions.

In some cases, an NE 102 may cluster (e.g., group) transmission and/or reception occasions for messages in the RACH procedure, referred to as ROs, in a time domain to improve network energy efficiency. For example, the NE 102 may enter a sleep mode for a longer duration if the ROs are clustered. However, if the ROs are clustered in the time domain, then multiple UEs compete for uplink grant resources explicitly indicated in Msg2, leading to increased collisions and retransmissions and increased latency for the RACH procedure. Having clustered ROs also increases the successive reception of preambles at an NE 102. The NE 102 may send multiple RAR messages corresponding to the preambles, which is followed by Msg3 transmission, leading to inefficient resource allocation and high signaling overhead due to the uplink grant information in the RAR messages.

According to implementations, one or more of the NEs 102 and the UEs 104 are operable to implement various aspects of the techniques described with reference to the present disclosure. For example, a UE 104 may transmit a Msg1 of a RACH procedure to an NE 102 (e.g., gNB, base station) that includes a random access preamble. The UE 104 may receive a Msg2 from the NE 102 that includes a RAR without an explicit indication of time-frequency resources to utilize for a Msg3 transmission (e.g., without an uplink grant). The UE 104 and the NE 102 determine one or more time-frequency resources for transmission of the Msg3 according to one or more associations between the time-frequency resources, the Msg1, and the Msg2. The associations may include, but are not limited to, a mapping between ROs and time-frequency resources (e.g., CG resources). The associations may be based on indices, where a RO index directly corresponds to a time-frequency resource index, or based on preamble indices, where a preamble maps to a time-frequency resource. Additionally, or alternatively, the associations may utilize OCC sequence indices indicated in the Msg2 to determine the time-frequency resources for the Msg3. In some cases, the NE 102 may configure the associations via signaling or messages to the UE 104 (e.g., SIBs, semi-static signaling, or other control signaling). In some other cases, the associations may be preconfigured or defined at the UE 104.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

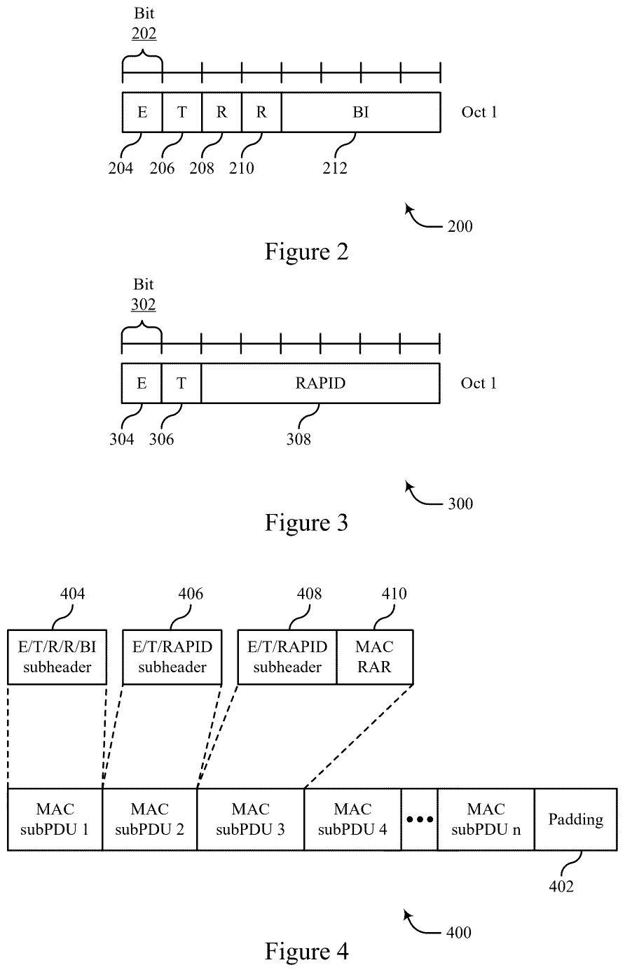

FIG. 2 illustrates an example of a resource diagram 200 in accordance with aspects of the present disclosure. In some examples, the resource diagram 200 implements or is implemented by aspects of the wireless communications system 100. For example, the resource diagram 200 may be implemented by a UE and/or an NE, which may be an example of an NE 102 and a UE 104 as described with reference to FIG. 1. The resource diagram 200 may be an example of a MAC subheader of a MAC subPDU.

In some cases, an NE may send a MAC PDU for a RAR as part of a RACH procedure. The MAC PDU may include one or more MAC subPDUs and optionally one or more padding bits. Padding bits may be additional bits added to a MAC subPDU to align the data structure to a defined size (e.g., byte boundaries) or to fill unused space within the PDU, such as when an actual data content does not fully utilize an allocated transmission resources. A MAC subheader may be octet aligned, where an octet refers to a group of eight bits (e.g., a byte). The data structure boundaries of the MAC subheader may align with the eight bit boundaries to be octet aligned. The resource diagram 200 illustrates an example of a single octet (e.g., Oct 1). Each MAC subPDU may include a MAC subheader that provides control information for the corresponding subPDU. The MAC subheader illustrated in the resource diagram 200 may include one or more fields that span one or more bits 202, such as five fields that span eight bits. The fields may include, but are not limited to, an extension field 204, a type identifier field 206, one or more reserved bit fields (e.g., reserved bits 208 and reserved bits 210), and a backoff indicator (BI) field 212. The fields enable a receiving device (e.g., a UE) to parse and process the MAC subPDU content. The NE may place a MAC subPDU with a BI field 212 at the beginning of the MAC PDU, if included.

The extension field 204 may be a single bit flag indicating whether the MAC subPDU including the MAC subheader is a last MAC subPDU in a MAC PDU. In some cases, the extension field 204 may be set to a value of one to indicate that at least one other MAC subPDU follows the MAC subPDU including the MAC subheader. In some other cases, the extension field 204 may be set to a value of zero to indicate that the MAC subPDU including the MAC subheader is the last MAC subPDU in the MAC PDU. The type identifier field 206 may be a single bit flag indicating whether the MAC subheader includes a RAPID field or a BI field 212. The type identifier field 206 may be set to a value of zero to indicate the presence of a BI field 212 in the MAC subheader. The type identifier field 206 may be set to a value of one to indicate the presence of a RAPID field in the MAC subheader. The reserved bit fields (e.g., reserved bits 208 and reserved bits 210) may be reserved bits that are set to values of zero. The BI field 212 may indicate an overload condition of a cell, such as if a number of random access attempts exceeds a defined threshold, if network congestion is detected according to resource utilization metrics, or if the NE determines that additional access attempts are to be delayed to manage network load. A size of the BI field 212 may be four bits.

FIG. 3 illustrates an example of a resource diagram 300 in accordance with aspects of the present disclosure. In some examples, the resource diagram 300 implements or is implemented by aspects of the wireless communications system 100 and/or the resource diagram 200. For example, the resource diagram 300 may be implemented by a UE and/or an NE, which may be an example of an NE 102 and a UE 104 as described with reference to FIG. 1. The resource diagram 300 may be an example of a MAC subheader of a MAC subPDU.

The resource diagram 300 illustrates an example of a single octet (e.g., Oct 1). The MAC subheader illustrated in the resource diagram 300 may include one or more fields that span one or more bits 302, such as three fields that span eight bytes. The fields may include, but are not limited to, an extension field 304, a type identifier field 306, and a RAPID field 308. The extension field 304 and the type identifier field 306 may be examples of the corresponding fields as described with reference to FIG. 2. The RAPID field 308 indicates a transmitted random access preamble (e.g., from a Msg1). A size of the RAPID field is six bits. An NE may include the RAPID field 308 in a MAC subheader following an extension field 304 and type identifier field 306. If the RAPID in the MAC subheader of a MAC subPDU corresponds to one of the random access preambles configured for a system information request, then a MAC RAR is not included in the MAC subPDU.

FIG. 4 illustrates an example of a resource diagram 400 in accordance with aspects of the present disclosure. In some examples, the resource diagram 400 implements or is implemented by aspects of the wireless communications system 100, the resource diagram 200, and/or the resource diagram 300. For example, the resource diagram 400 may be implemented by a UE and/or an NE, which may be an example of an NE 102 and a UE 104 as described with reference to FIG. 1. The resource diagram 400 illustrates a MAC PDU structure including one or more MAC subPDUs and optional padding bits 402.

The resource diagram 400 includes MAC subPDU 1 through MAC subPDU n, where n may be an integer value. Each MAC subPDU may include a MAC subheader 404 with a BI field, as described with reference to FIG. 2, a MAC subheader 406 with a RAPID field, as described with reference to FIG. 3 (e.g., acknowledgment for a system information request), or a MAC subheader 408 with a RAPID field and a MAC RAR 410. A MAC subPDU with the MAC subheader 404 (e.g., the BI field) may be located at a beginning of a MAC PDU, if included, such as in the MAC subPDU 1. One or more MAC subPDUs with the MAC subheader 406 (e.g., the RAPID field and no RAR) and the MAC subheader 408 with the MAC RAR 410 may be located anywhere between the MAC subPDU with the MAC subheader 404 and the padding bits 402, such as in the MAC subPDU 2 through the MAC subPDU n. The presence and length of the padding bits 402 is implicit based on a transport block (TB) size and a size of the MAC subPDUs.

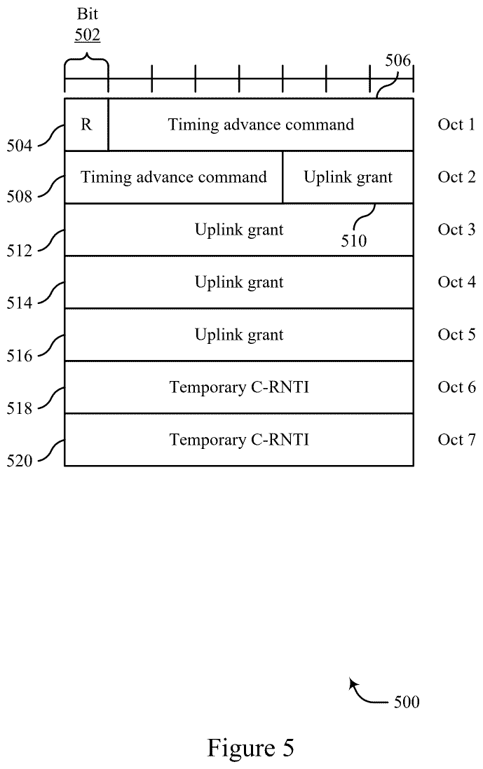

FIG. 5 illustrates an example of a resource diagram 500 in accordance with aspects of the present disclosure. In some examples, the resource diagram 500 implements or is implemented by aspects of the wireless communications system 100 and/or the resource diagram 200 through the resource diagram 400. For example, the resource diagram 500 may be implemented by a UE and/or an NE, which may be an example of an NE 102 and a UE 104 as described with reference to FIG. 1. The resource diagram 500 may be an example of a MAC RAR structure.

The resource diagram 500 illustrates a MAC RAR structure that spans multiple octets (e.g., October 1 through Oct 7). The MAC RAR includes one or more fields that span one or more bits 502, including a reserved bit field 504, a timing advance command field 506, a timing advance command field 508, an uplink grant field 510, an uplink grant field 512, an uplink grant field 514, an uplink grant field 516, a temporary C-RNTI field 518, and a temporary C-RNTI field 520. The bits in the reserved bit field 504 are set to a value of zero. The timing advance command field 506 and the timing advance command field 508 span twelve bits across October 1 and a portion of October 2, and indicate an index value used to control a timing adjustment that a MAC entity applies. The uplink grant field 510 through the uplink grant field 516 span 27 bits across a portion of October 2 through October 5, and indicate one or more time-frequency resources for a UE to utilize for an uplink transmission. The allocation of 27 bits for the uplink grant fields may reduce the overall efficiency of the MAC RAR structure by consuming a majority (e.g., greater than a threshold) of the available bits that could otherwise be utilized for additional UE responses or other control information. The temporary C-RNTI field 518 and the temporary C-RNTI field 520 span 16 bits across October 6 and October 7, and indicate a temporary identity used by the MAC entity during random access. The MAC RAR is octet aligned, with boundaries between each octet.

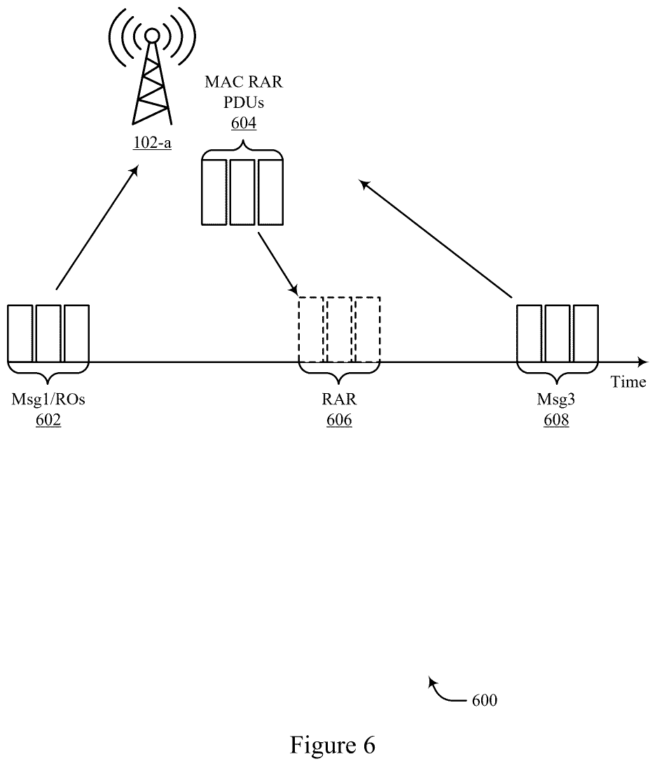

FIG. 6 illustrates an example of a signaling diagram 600 in accordance with aspects of the present disclosure. In some examples, the signaling diagram 600 implements or is implemented by aspects of the wireless communications system 100 and/or the resource diagram 200 through the resource diagram 500. The signaling diagram 600 may implement or be implemented by one or more devices, such as an NE 102-a and a UE, which may be examples of an NE 102 and a UE 104 as described with reference to FIG. 1. The signaling diagram 600 may illustrate an example of a RACH procedure between an NE 102-a and a UE. Alternative examples of the following may be implemented, where some processes are performed in a different order than described or are not performed. In some cases, processes may include additional features not mentioned below, or further processes may be added.

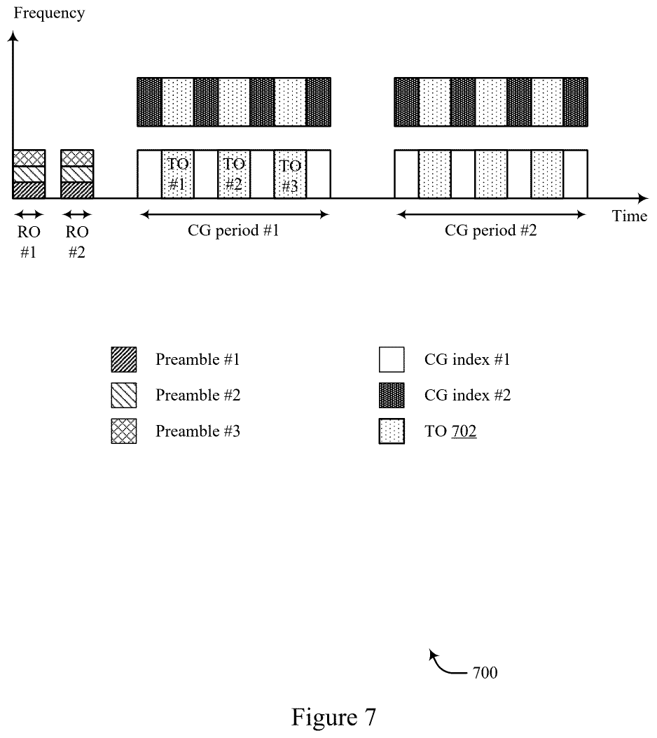

In some cases, an NE 102-a may receive one or more Msg1 transmissions of a four-step RACH procedure from one or more UEs during one or more ROs (e.g., Msg1/ROs 602). The NE 102-a may process the Msg1 transmissions and respond with one or more MAC RAR PDUs 604 in one or more RARs 606, which may be examples of Msg2 transmissions in the four-step RACH procedure. The NE 102-a may receive one or more Msg3 transmissions 608 from one or more UEs in response to the MAC RAR PDUs 604. In some examples, each RO may include multiple preambles, which is described in further detail with respect to FIG. 7. A single MAC RAR PDU may include up to 64 subPDUs, where each subPDU may include a RAPID field followed by an uplink grant. Clustered ROs mean that multiple MAC PDUs are transmitted successively for each RO. Minimizing the payload of MAC PDUs enables multiple subPDUs to be concatenated in a MAC PDU, resulting in sending combined RARs for multiple ROs. Sending combined RARs for multiple ROs enables more efficient handling of multiple random access attempts, such as for scenarios with numerous devices attempting concurrent network access.

A time-frequency resource configuration (e.g., a CG resource configuration) may include multiple time-frequency resources with configured periodicity values. The number of resources in a time period (e.g., CG period), the gap between time periods, and other parameters can be configurable as part of the time-frequency resource configuration. The time-frequency resources provide pre-allocated time-frequency resources that can be utilized for the Msg3 transmission without explicit uplink grant signaling in the RAR message, thereby reducing signaling overhead.

For example, the time-frequency resource determination for the Msg3 transmissions 608 can be defined according to a predetermined association. The association can map a reception of the Msg2 (e.g., RARs 606), the transmission of the Msg1 (e.g., Msg1/ROs 602), or a combination thereof. The NE 102-a may not transmit an uplink grant, including a time-frequency resource indication for the Msg3 transmissions, in the MAC subPDU in the RAR message for the corresponding RAPID in the MAC payload. If a UE receives a RAR 606 including a RAPID (e.g., the preamble identifier used for Msg1 transmission) with no associated uplink grant resource indication for the Msg3 transmission 608, then the UE may choose (e.g., determine, select) one or more uplink resources for the Msg3 transmission 608 using contention-based uplink transmission procedures or based on defined or configured associations (e.g., rules). Thus, the UE may determine one or more time-frequency resources for the Msg3 transmissions 608 based on associations with previously exchanged messages (e.g., Msg1/ROs 602 and RAR 606), rather than relying on explicit resource allocation in the RARs 606.

In some cases, the NE 102-a may provide semi-static configuration, such as in remaining minimum system information (RMSI) (e.g., a SIB1), to indicate a maximum time window. Additionally, or alternatively, the UE may be preconfigured with a maximum time period from the reception of a RAR 606 to the Msg3 transmission 608 or reception of a subsequent Msg3 acknowledgement from the NE 102-a. The time window depends on a numerology, such as subcarrier spacing (SCS), an uplink-downlink slot format, and/or device category or type. The time window defines a duration or period between the reception of the RAR 606 and the transmission of the Msg3 transmission 608, ensuring timing coordination in the RACH procedure, while accommodating different device types and network configurations.

FIG. 7 illustrates an example of a resource diagram 700 in accordance with aspects of the present disclosure. In some examples, the resource diagram 700 implements or is implemented by aspects of the wireless communications system 100, the resource diagram 200, the resource diagram 300 through the resource diagram 500, and/or the signaling diagram 600. For example, the resource diagram 700 may be implemented by a UE and/or an NE, which may be an example of an NE 102 and a UE 104 as described with reference to FIG. 1. The resource diagram 700 illustrates a mapping between ROs and time periods (e.g., CG periods) for a Msg3 transmission.

In some cases, a UE may transmit a Msg1 transmission to an NE that includes a random access preamble. The UE may receive a Msg2 transmission in response that includes a RAR without an explicit uplink grant for a Msg3 transmission. The UE may determine one or more time-frequency resources (e.g., CG resources) for the Msg3 transmission utilizing associations between ROs and CG resources. Although reference is made herein to CG resources, the time-frequency resources may be any type of resource.

In some examples, the NE can indicate a set of one or more time-frequency resources for a Msg3 transmission using a semi-static configuration, such as in RMSI (e.g., SIB1) in control signaling. A RAR message may activate at least one of the time-frequency resources in the set of time-frequency resources. For example, the NE may include a time-frequency resource index in the set of time-frequency resources (e.g., 3 bits) in each RAR subPDU following a RAPID field. The time-frequency resource index may be instead of the uplink grant (e.g., explicit indication of a time in the time domain and frequency in the frequency domain). The UE may utilize the time-frequency resource corresponding to the time-frequency resource index for transmission of a Msg3. The NE can signal the time-frequency resource, a modulation and coding scheme (MCS), and one or more other communication parameters for the time-frequency resources in the set of time frequency resources (e.g., CGs) in the RMSI. A CG period can include multiple TOs 702, with each TO 702 representing a time-frequency resource that the UE can use for the Msg3 transmission.

If the NE does not include the uplink grant or a time-frequency resource index in the RAR subPDU, then the UE may choose (e.g., select, identify, determine) one of the time-frequency resources within a configured time window. In some cases, the NE may associate a time-frequency index to a device type or category using semi-static signaling. A UE selects a time-frequency resource index according to a device type or category of the UE. Additionally, or alternatively, the NE can configure one or more time windows according to the device type. The device type can include, but is not limited to, an MBB device type and an IoT device type. In the resource diagram 700, the NE and the UE associate different CG indices (e.g., CG index #1 and CG index #2) with different device types, providing for resource allocation on a device type basis. The NE may assign CG index #1 resources to MBB devices, while assigning CG index #2 resources to IoT devices. In some cases, the UE may utilize the reception of a RAR subPDU as an activation of a time-frequency resource. For example, the NE may not include an explicit CG index in the RAR subPDU. Instead, the UE may receive the RAR subPDU including a RAPID of the UE, which may implicitly activate a time-frequency resource for the device type of the UE for the Msg3 transmission.

The UE can determine a number of repetitions for a Msg3 transmission as a function of an SSB-RSRP indicated in a SIB1 message. For example, the UE may select the number of repetitions depending on a measurement of a received SSB, which the UE uses for the transmission of Msg1 and by comparing the measured SSB-RSRP against one or more configured SSB-RSRP thresholds. For example, if the difference between the SSB-RSRP threshold the NE indicates in the SIB1 and the SSB-RSRP the UE measures exceeds a defined threshold value, then the UE may increase a number of repetitions for the Msg3 transmission.

The NE and UE may implement a mapping association between a resource utilized for the Msg1 transmission and the time-frequency resources utilized for the Msg3 transmission. The UE selects the time-frequency resources to utilize for the Msg3 transmission based on the Msg1 resource. For example, the NE and/or the UE may map ROs (e.g., RO #1 and RO #2) including multiple preambles to defined CG periods and TOs 702 for subsequent Msg3 transmissions. The NE can configure a one-to-one resource mapping or one-to-many resource mapping between a Msg1 resource occasion and Msg3 resource occasions. In some examples, the NE configures resource mapping between ROs including multiple preambles and one or more time-frequency resource configurations. Each CG configuration may include one or more TOs 702 within a time period (e.g., CG period). The UE and NE can base the mapping on one or more rules.

For example, the NE can configure each RO to a CG index with ascending order of ROs configured to the ascending order of CG index from one or more CG resources the NE configures using semi-static signaling. For example, the NE may map RO #1 to CG index #1 and RO #2 to CG index #2, establishing an association between the RO the UE uses for Msg1 and the CG resource the UE uses for Msg3. The NE can map each RACH preamble within each RO to one or more CG periods within a CG resource. The NE may map ascending order of RACH preamble index to ascending order of CG period, while CG period may include one or more TOs 702 and the length of the CG period depends on the time window the NE configures. For example, the NE may map Preamble #1, Preamble #2, and Preamble #3 within a RO to defined TOs 702 within the corresponding CG period.

In some other examples of a mapping or association between Msg1 and Msg3, the NE may associate each RACH preamble to a CG index with ascending order of RACH preamble index mapped to the ascending order of CG index. The NE may implement the RACH preamble to CG index mapping to implement more granular resource allocation, where individual preambles within an RO determine the CG resource the UE uses. The NE may associate ROs to CG periods in a CG index. The NE associates the ascending order of RO to ascending order of CG periods. For example, the UE transmitting in RO #1 may use TOs in CG period #1, while a UE transmitting in RO #2 may use TOs in CG period #2. UEs that send a PRACH in an initial RO may use the first CG resources for the Msg3 transmission after the successful reception of RAR message, while UEs transmitting a PRACH in later ROs may use later CG resources for the Msg3 transmission. Thus, UEs transmitting in different ROs have distinct resources for Msg3 transmission, reducing potential collisions.

In some other examples of mapping or association between Msg1 and Msg3, the NE implements a mapping rule to associate RACH preambles, ROs, OCC sequence length, and/or OCC sequence index used for a Msg3 physical uplink shared channel (PUSCH). The NE may associate each preamble to an OCC sequence index with ascending order of preamble index mapped to ascending order of OCC sequence index. Thus, the NE may leverage OCC sequences to differentiate Msg3 transmissions from different UEs, even if the UEs share same time-frequency resources. The NE may associate each RO to a CG period with ascending order of RO associated to ascending order of CG period index in a CG resource (e.g., CG configuration index). The NE may also implement a combination of the described associations or mappings.

In some cases, the NE may determine how many PRACHs the NE receives, including RAPIDs, and with cyclic DMRS configuration within each Msg3 PUSCH, the NE may identify collisions even though the NE may not successfully decode a Msg3 transmission. For example, the NE can implement a mapping association between a Msg1 preamble and/or ROs to that of the Msg3 PUSCH DMRS cyclic shifts or DMRS time-frequency pattern or comb-x pattern or density selected in a CG resource. After identifying the collision, the NE may provide a dynamic uplink grant using downlink control information (DCI) signaling including a RAPID and/or DMRS ID. The NE may configure the UE to monitor DCI in a new search space monitoring occasions within a control resource set (CORESET) #0 to receive the dynamic uplink grant within a configured time window.

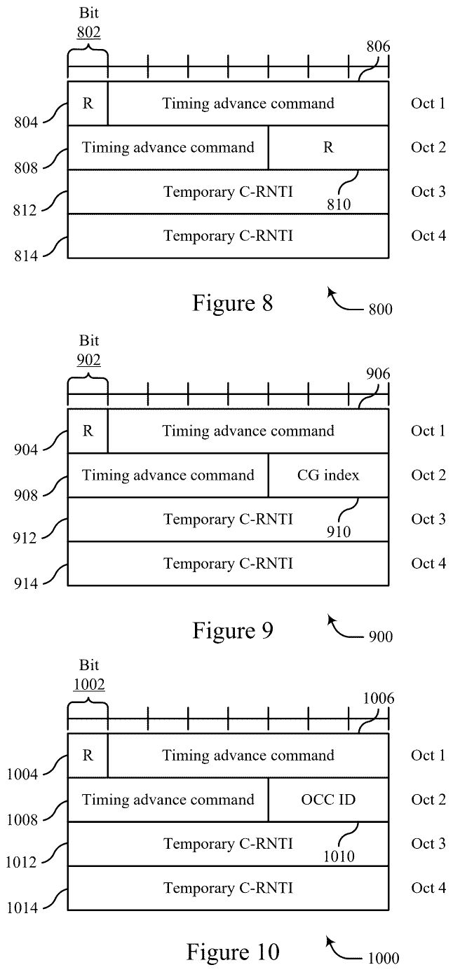

FIG. 8 illustrates an example of a resource diagram 800 in accordance with aspects of the present disclosure. In some examples, the resource diagram 800 implements or is implemented by aspects of the wireless communications system 100, the resource diagram 200 through the resource diagram 500, the signaling diagram 600, and/or the resource diagram 700. For example, the resource diagram 800 may be implemented by a UE and/or an NE, which may be an example of an NE 102 and a UE 104 as described with reference to FIG. 1. The resource diagram 800 illustrates a MAC subheader of a RAR subPDU structure without uplink grant fields.

The resource diagram 800 illustrates an example of a RAR subPDU with multiple octets (e.g., October 1 through Oct 4). The MAC subheader illustrated in the resource diagram 800 may include one or more fields that span one or more bits 802, such as multiple fields that span across the octets. The fields may include, but are not limited to, reserved bits 804, a timing advance command field 806, a timing advance command field 808, reserved bits 810, a temporary C-RNTI field 812, and a temporary C-RNTI field 814. The reserved bits 804 and the reserved bits 810 may be set to values of zero. The timing advance command field 806 and the timing advance command field 808 may indicate an index value used to control a timing adjustment that a MAC entity applies. The temporary C-RNTI field 812 and the temporary C-RNTI field 814 may indicate a temporary identity used by the MAC entity during random access. The MAC subheader may be octet aligned.

FIG. 9 illustrates an example of a resource diagram 900 in accordance with aspects of the present disclosure. In some examples, the resource diagram 900 implements or is implemented by aspects of the wireless communications system 100, the resource diagram 200 through the resource diagram 500, the signaling diagram 600, the resource diagram 700, and/or the resource diagram 800. For example, the resource diagram 900 may be implemented by a UE and/or an NE, which may be an example of an NE 102 and a UE 104 as described with reference to FIG. 1. The resource diagram 900 illustrates a MAC subheader of a RAR subPDU structure without uplink grant fields.

The resource diagram 900 illustrates an example of a RAR subPDU with multiple octets (e.g., October 1 through Oct 4). The MAC subheader illustrated in the resource diagram 900 may include one or more fields that span one or more bits 902, such as multiple fields that span across the octets. The fields may include, but are not limited to, reserved bits 904, a timing advance command field 906, a timing advance command field 908, a CG index field 910 (e.g., a time-frequency resource index), a temporary C-RNTI field 912, and a temporary C-RNTI field 914. The reserved bits 904 may be set to values of zero. The timing advance command field 906 and the timing advance command field 908 may indicate an index value used to control a timing adjustment that a MAC entity applies. The CG index field 910 provides an index value that the UE can use to identify a CG resource for the Msg3 transmission. The temporary C-RNTI field 912 and the temporary C-RNTI field 914 may indicate a temporary identity used by the MAC entity during random access. The MAC subheader may be octet aligned.

FIG. 10 illustrates an example of a resource diagram 1000 in accordance with aspects of the present disclosure. In some examples, the resource diagram 1000 implements or is implemented by aspects of the wireless communications system 100, the resource diagram 200 through the resource diagram 500, the signaling diagram 600, and/or the resource diagram 700 through the resource diagram 900. For example, the resource diagram 1000 may be implemented by a UE and/or an NE, which may be an example of an NE 102 and a UE 104 as described with reference to FIG. 1. The resource diagram 1000 illustrates a MAC subheader of a RAR subPDU structure without uplink grant fields.

The resource diagram 1000 illustrates an example of a RAR subPDU with multiple octets (e.g., October 1 through Oct 4). The MAC subheader illustrated in the resource diagram 900 may include one or more fields that span one or more bits 1002, such as multiple fields that span across the octets. The fields may include, but are not limited to, reserved bits 1004, a timing advance command field 1006, a timing advance command field 1008, an OCC ID field 1010, a temporary C-RNTI field 1012, and a temporary C-RNTI field 1014. The reserved bits 1004 may be set to values of zero. The timing advance command field 1006 and the timing advance command field 1008 may indicate an index value used to control a timing adjustment that a MAC entity applies. The OCC ID field 1010 may provide an OCC ID that the UE can use to determine which OCC sequence to apply for the Msg3 transmission, enabling differentiation between multiple UEs that may share same time-frequency resources. In some cases, the OCC ID field 1010 may utilize a defined number of bits to indicate different OCC sequences available for the Msg3 transmission. The temporary C-RNTI field 1012 and the temporary C-RNTI field 1014 may indicate a temporary identity used by the MAC entity during random access. The MAC subheader may be octet aligned. The structures depicted in FIGS. 8 through 10 may be combined to provide flexible RAR subPDU configurations that can accommodate different network scenarios and device criterion.

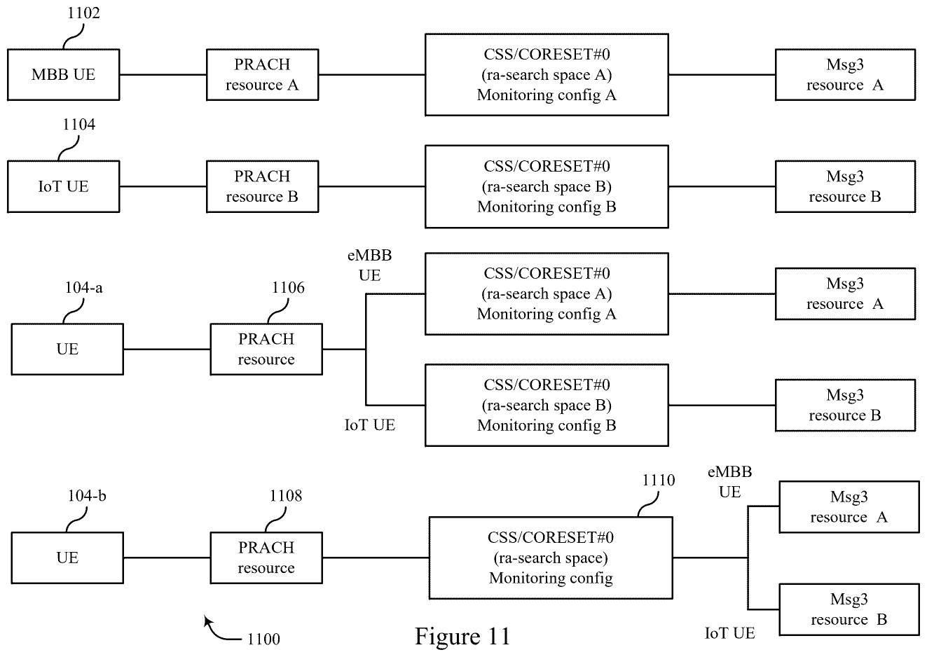

FIG. 11 illustrates an example of a resource association diagram 1100 in accordance with aspects of the present disclosure. In some examples, the resource association diagram 1100 implements or is implemented by aspects of the wireless communications system 100, the resource diagram 200 through the resource diagram 500, the signaling diagram 600, and/or the resource diagram 700 through the resource diagram 1000. For example, the resource association diagram 1100 may be implemented by an MBB UE 1102, an IoT UE 1104, a UE 104-a, and/or a UE 104-b, which may be an example of UEs 104 as described with reference to FIG. 1. The UE 104-a and/or the UE 104-b may be examples of MBB UEs, such as an enhanced MBB (eMBB) UE, or IoT UEs. The resource association diagram 1100 illustrates various examples for differentiating device types and/or categories during initial access.

In some cases, after sending a Msg1 (e.g., PRACH), a UE starts a random access response window (e.g., ra-ResponseWindow) at a first physical downlink control channel (PDCCH) occasion that occurs after the end of the preamble transmission. While that window runs, the UE monitors for the PDCCH in the configured random access search space (e.g., ra-SearchSpace) for a random access-radio network temporary identifier (RA-RNTI). Upon detection, the UE reads a PDSCH with a RAR (e.g., Msg2). There can be an association between Ros, or a subset of configured Ros, to RAR common search space monitoring occasions, where the ROs and common search space monitoring occasions can be associated or mapped according to a device type or category. In some examples, a UE may indicate a device category or a feature using a preamble by partitioning preambles with respect to a device category or feature. Different device categories may have different RAR window timing and different ra-SearchSpace monitoring occasions. If a preamble or ROs are associated with a device category or type, then the preamble or ROs may also be associated with a corresponding ra-SearchSpace monitoring occasions.

The resource association diagram 1100 illustrates one or more combination of methods to differentiate device types or categories during initial access. The methods include utilizing preamble partitioning using separate PRACH resources, followed by separate CSS/CORESET #0, ra-search space monitoring occasions, and Msg3 resources. Additionally, or alternatively, the methods include utilizing same PRACH resources, where UEs according to a device type may monitor different ra-search space monitoring occasions and Msg3 resources. Additionally, or alternatively, the methods include utilizing same PRACH and ra-search space monitoring occasions with separate Msg3 resources configured according to different device types, where UEs may autonomously select CG index according to device type or category or using one or more defined rules or associations, as described with reference to FIGS. 1 through 10.

The resource association diagram 1100 may include an MBB UE 1102 and an IoT UE 1104, representing different device categories that may utilize distinct resource allocation strategies. Each UE type utilizes PRACH resources, which serve as the initial access points for random access procedures. For example, the MBB UE 1102 utilizes a PRACH resource A, the IoT UE 1104 utilizes a PRACH resource B, the UE 104-a utilizes a PRACH resource 1106, and a UE 104-b utilizes a PRACH resource 1108. The PRACH resources may be associated with different common search space (CSS) and/or CORESET #0 configurations in a random access search space A or B (e.g., ra-search space A or ra-search space B). A monitoring configuration, such as the monitoring config 1110, represents various monitoring occasions that may be configured for different device types, including, but not limited to, a monitoring periodicity, a monitoring offset, duration, and monitoring symbols within a slot.

In some cases, the resource association diagram 1100 may illustrate preamble partitioning in which separate PRACH resources are allocated for different device categories, followed by separate CSS/CORESET0 and ra-search space monitoring occasions. The resource association diagram 1100 may also represent scenarios in which same PRACH resources are utilized, but UEs monitor different ra-search space monitoring occasions based on a device type. For example, a UE may autonomously select a monitoring configuration according to a device type or category. The monitoring configuration 1110 may encompass various association methods between ROs or subsets of configured ROs and RAR common search space monitoring occasions. The associations may be mapped according to device type or category, enabling differentiated treatment of MBB devices versus IoT devices (e.g., the MBB UE 1102 and the IoT UE 1104). In some cases, UEs may use same PRACH and ra-search space monitoring occasions, but separate Msg3 resources (e.g., Msg3 resource A and/or Msg3 resource B) according to different device types, providing for UEs to autonomously select CG indices based on a device category or using predefined rules.

In some cases, each search space mapped to a CORESET may be configured with a numerical quantity (e.g., number, amount) of control channel elements. Additionally, or alternatively, each search space mapped to a CORESET may be configured with a transmission configuration index (TCI) state, a beam index, and/or a spatial filter. A search space configured for a UE indicates time domain monitoring occasions within a slot, time domain monitoring occasions across a slot, and/or a spatial filter to receive a transmission. An NE may transmit a dynamic indication to update (e.g., change, indicate) the spatial filter for a search space. The NE may transmit the dynamic indication using low power radio signaling, using a MAC-control element (MAC-CE), and/or DCI with an offset.

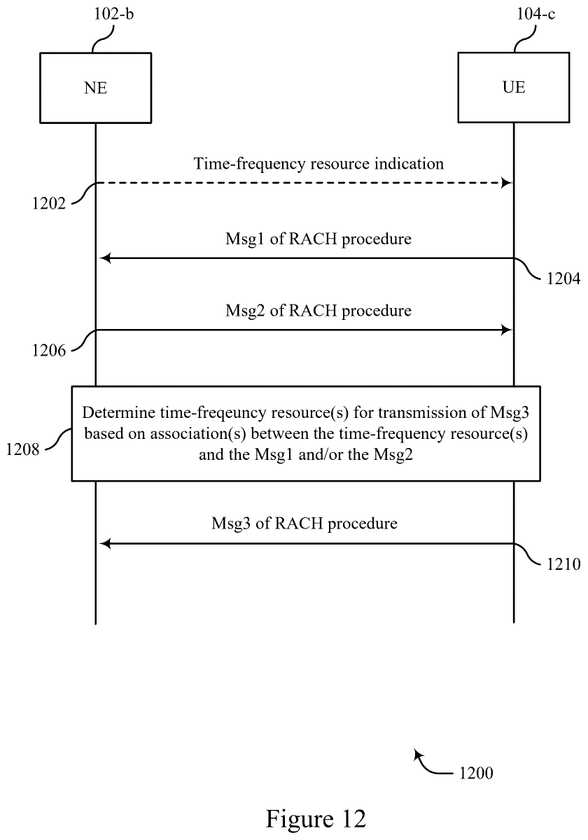

FIG. 12 illustrates an example of a signaling diagram 1200 in accordance with aspects of the present disclosure. In some examples, the signaling diagram 1200 implements or is implemented by aspects of the wireless communications system 100, the resource diagram 200 through the resource diagram 500, the signaling diagram 600, the resource diagram 700 through the resource diagram 1000, and/or the resource association diagram 1100. The signaling diagram 1200 may implement or be implemented by an NE 102-b and a UE 104-c, which may be examples of an NE 102 and a UE 104 as described with reference to FIG. 1. The signaling diagram 1200 illustrates an example of a RACH procedure between an NE 102-b and a UE 104-c that implements resource determination for Msg3 transmission based on associations with previous messages in the RACH procedure. Alternative examples of the following may be implemented, where some processes are performed in a different order than described or are not performed. In some cases, processes may include additional features not mentioned below, or further processes may be added.

In some cases, at 1202, the NE 102-b transmits a time-frequency resource indication to the UE 104-c. The time-frequency resource indication may include a SIB that indicates one or more time-frequency resources (e.g., CG resources) available for a Msg3 transmission of a RACH procedure. In some examples, the SIB may also indicate one or more SSB-RSRP threshold values. The time-frequency resource indication may be an example of semi-static signaling, such as RMSI and/or a MAC-CE, among other example signaling, that configures associations between ROs and time-frequency resources. The time-frequency resource indication may establish information and/or a set of time-frequency resources for subsequent resource determination without explicit uplink grant signaling in RAR messages.

At 1204, the UE 104-c transmits a Msg1 of the RACH procedure to the NE 102-b. The Msg1 includes a random access preamble selected from a configured set of preamble sequences. The UE 104-c may select the preamble according to various factors, such as path loss measurements, device type, or access criterion. The preamble transmission serves multiple purposes, including initial timing synchronization with the NE 102-b, indication of the presence of the UE 104-c and access attempt, and in some cases, conveying information about one or more capabilities of the UE 104-c or service criterion of the UE 104-c through the selection of the preamble sequence.

At 1206, the NE 102-b transmits a Msg2 of the RACH procedure to the UE 104-c. The Msg2 includes a RAR that includes a RAPID to identify the preamble being responded to, a timing advance command to adjust the transmission timing of the UE 104-c for uplink synchronization, and a temporary C-RNTI for subsequent communications. The Msg2 does not include an explicit uplink grant that indicates time-frequency resources for the transmission of the Msg3 of the RACH procedure, thereby reducing signaling overhead. In some cases, the Msg2 may include an index of the time-frequency resource (e.g., in the set of configured time-frequency resources at 1202) or an OCC index to facilitate resource determination.

At 1208, the NE 102-b and/or the UE 104-c determine one or more time-frequency resources for reception and/or transmission, respectively, of the Msg3 of the RACH procedure. The determination is based on at least one of a first association between the time-frequency resource and the Msg2 or a second association between the time-frequency resource and the Msg1. The associations may include a mapping between ROs and time-frequency resources. In some cases, ROs may include multiple RACH preambles, and respective time-frequency resources include one or more TOs for the Msg3 transmission within a time period. The associations may be based on ascending order of indices for time-frequency resources and ROs, ascending order of time periods for the time-frequency resources and indices for the RACH preambles, or ascending order of OCC indices and indices for RACH preambles.

At 1210, the UE 104-c transmits the Msg3 of the RACH procedure to the NE 102-b. In some cases, the UE 104-c determines the same time-frequency resource for transmission of Msg3 using the same associations as the NE 102-b. The UE 104-c may select a numerical quantity of repetitions for the Msg3 transmission based on comparing a difference between SSB-RSRP values indicated in the SIB at 1202 and measured SSB-RSRP to one or more SSB-RSRP threshold values. The Msg3 transmission utilizes the determined time-frequency resource (e.g., CG resource) without relying on explicit uplink grant information from the Msg2, thereby enabling more efficient resource allocation and reduced signaling overhead in the RACH procedure.

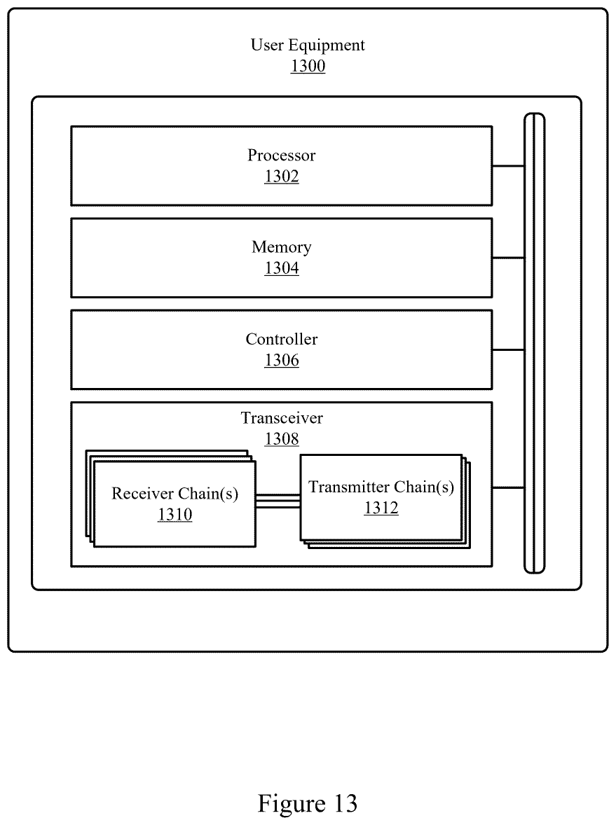

FIG. 13 illustrates an example of a UE 1300 in accordance with aspects of the present disclosure. The UE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a central processing unit (CPU), an ASIC, a field-programmable gate-array (FPGA), or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the UE 1300 to perform various functions of the present disclosure.

The memory 1304 may include volatile or non-volatile memory. The memory 1304 may store computer-readable, computer-executable code including instructions when executed by the processor 1302 cause the UE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the UE 1300 to perform one or more of the functions described herein (e.g., executing, by the processor 1302, instructions stored in the memory 1304). For example, the processor 1302 may support wireless communication at the UE 1300 in accordance with examples as disclosed herein. The UE 1300 may be configured to or operable to support a means for transmitting a first message of a RACH procedure, receiving, based on the first message, a second message of the RACH procedure, determining a time-frequency resource for transmission of a third message of the RACH procedure based on at least one of a first association between the time-frequency resource and the second message or a second association between the time-frequency resource and the first message, and transmitting the third message of the RACH procedure based on the time-frequency resource.

Additionally, the UE 1300 may be configured to or operable to support any one or combination of receiving a SIB that indicates one or more time-frequency resources including the time-frequency resource. Additionally, or alternatively, the UE 1300 may be configured to or operable to support the second message indicates the first association based on an index corresponding to the time-frequency resource from the one or more time-frequency resources and reception of the second message activates the time-frequency resource. Additionally, or alternatively, the second message fails to indicate an index associated with the time-frequency resource from the one or more time-frequency resources and the UE 1300 may be configured to or operable to support selecting the time-frequency resource from the one or more time-frequency resources within a time window based on the first association. Additionally, or alternatively, the UE 1300 may be configured to or operable to support the time window is based on a device type associated with the UE. Additionally, or alternatively, the UE 1300 may be configured to or operable to support receiving a SIB that indicates a first SSB-RSRP, receiving an SSB associated with a second SSB-RSRP, and selecting a numerical quantity of repetitions associated with the third message based on comparing a difference between the first SSB-RSRP and the second SSB-RSRP to one or more SSB-RSRP threshold values.

Additionally, or alternatively, the UE 1300 may be configured to or operable to support the first association is between one or more ROs and one or more time-frequency resources where the one or more ROs are associated with a set of RACH preambles including a RACH preamble corresponding to the first message and respective time-frequency resources of the one or more time-frequency resources include one or more TOs for the transmission of the third message within a time period. Additionally, or alternatively, the UE 1300 may be configured to or operable to support receiving semi-static signaling that indicates the one or more time-frequency resources and the first association is based on an ascending order of first indices associated with the one or more time-frequency resources and second indices associated with the one or more ROs. Additionally, or alternatively, the UE 1300 may be configured to or operable to support the first association is based on an ascending order of respective time periods associated with the one or more time-frequency resources and indices associated with respective RACH preambles of the set of RACH preambles where a duration of the respective time periods is based on a time window and the time window is based on a device type associated with the UE. Additionally, or alternatively, the UE 1300 may be configured to or operable to support the first association is based on an ascending order of first indices associated with the one or more time-frequency resources and second indices associated with respective RACH preambles of the set of RACH preambles. Additionally, or alternatively, the UE 1300 may be configured to or operable to support the first association is based on an ascending order of indices associated with the one or more ROs and respective time periods associated with the one or more time-frequency resources. Additionally, or alternatively, the UE 1300 may be configured to or operable to support the set of RACH preambles are associated with respective OCC sequence indices and the first association is based on an ascending order of the respective OCC sequence indices and indices associated with respective RACH preambles of the set of RACH preambles.

Additionally, or alternatively, the UE 1300 may be configured to or operable to support receiving signaling that indicates an additional time-frequency resource associated with the third message based on a collision between the third message and an additional message and transmitting the third message of the RACH procedure based on the additional time-frequency resource. Additionally, or alternatively, the UE 1300 may be configured to or operable to support the second message includes one or more of a RAPID associated with the first message, a timing advance, a temporary C-RNTI, or an index associated with the time-frequency resource. Additionally, or alternatively, the UE 1300 may be configured to or operable to support determining a third association between one or more ROs and one or more monitoring occasions associated with the second message. Additionally, or alternatively, the UE 1300 may be configured to or operable to support the time-frequency resource includes a CG resource.

Additionally, or alternatively, the UE 1300 may support at least one memory (e.g., the memory 1304) and at least one processor (e.g., the processor 1302) coupled with the at least one memory and configured to cause the UE to transmit a first message of a RACH procedure, receive, based on the first message, a second message of the RACH procedure, determine a time-frequency resource for transmission of a third message of the RACH procedure based on at least one of a first association between the time-frequency resource and the second message or a second association between the time-frequency resource and the first message, and transmit the third message of the RACH procedure based on the time-frequency resource.

Additionally, to determine the time-frequency resource, the UE 1300 may be configured to support any one or combination of to receive a SIB that indicates one or more time-frequency resources including the time-frequency resource. Additionally, or alternatively, the UE 1300 may be configured to or operable to support the second message indicates the first association based on an index corresponding to the time-frequency resource from the one or more time-frequency resources and reception of the second message activates the time-frequency resource. Additionally, or alternatively, the second message fails to indicate an index associated with the time-frequency resource from the one or more time-frequency resources and the UE 1300 may be configured to or operable to support to select the time-frequency resource from the one or more time-frequency resources within a time window based on the first association. Additionally, or alternatively, the UE 1300 may be configured to or operable to support the time window is based on a device type associated with the UE. Additionally, or alternatively, the UE 1300 may be configured to or operable to support to receive a SIB that indicates a first SSB-RSRP, receive an SSB associated with a second SSB-RSRP, and select a numerical quantity of repetitions associated with the third message based on comparing a difference between the first SSB-RSRP and the second SSB-RSRP to one or more SSB-RSRP threshold values.

Additionally, or alternatively, the UE 1300 may be configured to or operable to support the first association is between one or more ROs and one or more time-frequency resources, where the one or more ROs are associated with a set of RACH preambles including a RACH preamble corresponding to the first message and respective time-frequency resources of the one or more time-frequency resources include one or more TOs for the transmission of the third message within a time period. Additionally, or alternatively, the UE 1300 may be configured to or operable to support to receive semi-static signaling that indicates the one or more time-frequency resources and the first association is based on an ascending order of first indices associated with the one or more time-frequency resources and second indices associated with the one or more ROs. Additionally, or alternatively, the UE 1300 may be configured to or operable to support the first association is based on an ascending order of respective time periods associated with the one or more time-frequency resources and indices associated with respective RACH preambles of the set of RACH preambles where a duration of the respective time periods is based on a time window and the time window is based on a device type associated with the UE. Additionally, or alternatively, the UE 1300 may be configured to or operable to support the first association is based on an ascending order of first indices associated with the one or more time-frequency resources and second indices associated with respective RACH preambles of the set of RACH preambles. Additionally, or alternatively, the UE 1300 may be configured to or operable to support the first association is based on an ascending order of indices associated with the one or more ROs and respective time periods associated with the one or more time-frequency resources. Additionally, or alternatively, the UE 1300 may be configured to or operable to support the set of RACH preambles are associated with respective OCC sequence indices and the first association is based on an ascending order of the respective OCC sequence indices and indices associated with respective RACH preambles of the set of RACH preambles.

Additionally, or alternatively, the UE 1300 may be configured to or operable to support to receive signaling that indicates an additional time-frequency resource associated with the third message based on a collision between the third message and an additional message and transmit the third message of the RACH procedure based on the additional time-frequency resource. Additionally, or alternatively, the UE 1300 may be configured to or operable to support the second message includes one or more of a RAPID associated with the first message, a timing advance, a temporary C-RNTI, or an index associated with the time-frequency resource. Additionally, or alternatively, to receive the second message, the UE 1300 may be configured to or operable to support to determine a third association between one or more ROs and one or more monitoring occasions associated with the second message. Additionally, or alternatively, the UE 1300 may be configured to or operable to support the time-frequency resource includes a CG resource.

The controller 1306 may manage input and output signals for the UE 1300. The controller 1306 may also manage peripherals not integrated into the UE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the UE 1300 may include at least one transceiver 1308. In some other implementations, the UE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

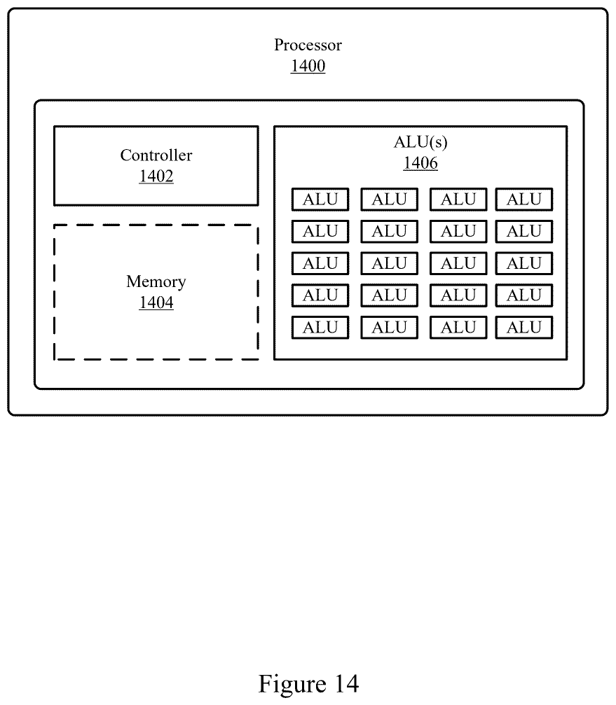

FIG. 14 illustrates an example of a processor 1400 in accordance with aspects of the present disclosure. The processor 1400 may be an example of a processor configured to perform various operations in accordance with examples as described herein. The processor 1400 may include a controller 1402 configured to perform various operations in accordance with examples as described herein. The processor 1400 may optionally include at least one memory 1404, which may be, for example, an L1/L2/L3 cache. Additionally, or alternatively, the processor 1400 may optionally include one or more arithmetic-logic units (ALUs) 1406. One or more of these components may be in electronic communication or otherwise coupled (e.g., operatively, communicatively, functionally, electronically, electrically) via one or more interfaces (e.g., buses).

The processor 1400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1402 may be configured to manage and coordinate various operations (e.g., signaling, receiving, obtaining, retrieving, transmitting, outputting, forwarding, storing, determining, identifying, accessing, writing, reading) of the processor 1400 to cause the processor 1400 to support various operations in accordance with examples as described herein. For example, the controller 1402 may operate as a control unit of the processor 1400, generating control signals that manage the operation of various components of the processor 1400. These control signals include enabling or disabling functional units, selecting data paths, initiating memory access, and coordinating timing of operations.

The controller 1402 may be configured to fetch (e.g., obtain, retrieve, receive) instructions from the memory 1404 and determine subsequent instruction(s) to be executed to cause the processor 1400 to support various operations in accordance with examples as described herein. The controller 1402 may be configured to track memory addresses of instructions associated with the memory 1404. The controller 1402 may be configured to decode instructions to determine the operation to be performed and the operands involved. For example, the controller 1402 may be configured to interpret the instruction and determine control signals to be output to other components of the processor 1400 to cause the processor 1400 to support various operations in accordance with examples as described herein. Additionally, or alternatively, the controller 1402 may be configured to manage flow of data within the processor 1400. The controller 1402 may be configured to control transfer of data between registers, ALUs 1406, and other functional units of the processor 1400.

The memory 1404 may include one or more caches (e.g., memory local to or included in the processor 1400 or other memory, such as RAM, ROM, DRAM, SDRAM, SRAM, MRAM, flash memory, etc. In some implementations, the memory 1404 may reside within or on a processor chipset (e.g., local to the processor 1400). In some other implementations, the memory 1404 may reside external to the processor chipset (e.g., remote to the processor 1400).

The memory 1404 may store computer-readable, computer-executable code including instructions that, when executed by the processor 1400, cause the processor 1400 to perform various functions described herein. The code may be stored in a non-transitory computer-readable medium such as system memory or another type of memory. The controller 1402 and/or the processor 1400 may be configured to execute computer-readable instructions stored in the memory 1404 to cause the processor 1400 to perform various functions. For example, the processor 1400 and/or the controller 1402 may be coupled with or to the memory 1404, the processor 1400, and the controller 1402, and may be configured to perform various functions described herein. In some examples, the processor 1400 may include multiple processors and the memory 1404 may include multiple memories. One or more of the multiple processors may be coupled with one or more of the multiple memories, which may, individually or collectively, be configured to perform various functions herein.

The one or more ALUs 1406 may be configured to support various operations in accordance with examples as described herein. In some implementations, the one or more ALUs 1406 may reside within or on a processor chipset (e.g., the processor 1400). In some other implementations, the one or more ALUs 1406 may reside external to the processor chipset (e.g., the processor 1400). One or more ALUs 1406 may perform one or more computations such as addition, subtraction, multiplication, and division on data. For example, one or more ALUs 1406 may receive input operands and an operation code, which determines an operation to be executed. One or more ALUs 1406 may be configured with a variety of logical and arithmetic circuits, including adders, subtractors, shifters, and logic gates, to process and manipulate the data according to the operation. Additionally, or alternatively, the one or more ALUs 1406 may support logical operations such as AND, OR, exclusive-OR (XOR), not-OR (NOR), and not-AND (NAND), enabling the one or more ALUs 1406 to handle conditional operations, comparisons, and bitwise operations.

The processor 1400 may support wireless communication in accordance with examples as disclosed herein. The processor 1400 may be configured to or operable to support at least one controller (e.g., the controller 1402) coupled with at least one memory (e.g., the memory 1404) and configured to cause the processor to transmit a first message of a RACH procedure, receive, based on the first message, a second message of the RACH procedure, determine a time-frequency resource for transmission of a third message of the RACH procedure based on at least one of a first association between the time-frequency resource and the second message or a second association between the time-frequency resource and the first message, and transmit the third message of the RACH procedure based on the time-frequency resource.

Additionally, to determine the time-frequency resource, the processor 1400 may be configured to or operable to support to receive a SIB that indicates one or more time-frequency resources including the time-frequency resource. Additionally, or alternatively, the processor 1400 may be configured to or operable to support any one or combination of the second message indicates the first association based on an index corresponding to the time-frequency resource from the one or more time-frequency resources and reception of the second message activates the time-frequency resource. Additionally, or alternatively, the processor 1400 may be configured to or operable to support any one or combination of the second message fails to indicate an index associated with the time-frequency resource from the one or more time-frequency resources and the processor selects the time-frequency resource from the one or more time-frequency resources within a time window based on the first association. Additionally, or alternatively, the processor 1400 may be configured to or operable to support any one or combination of the time window is based on a device type associated with the processor. Additionally, or alternatively, the processor 1400 may be configured to or operable to support any one or combination of to receive a SIB that indicates a first SSB-RSRP, receive an SSB associated with a second SSB-RSRP, and select a numerical quantity of repetitions associated with the third message based on comparing a difference between the first SSB-RSRP and the second SSB-RSRP to one or more SSB-RSRP threshold values.

Additionally, or alternatively, the processor 1400 may be configured to or operable to support any one or combination of the first association is between one or more ROs and one or more time-frequency resources where the one or more ROs are associated with a set of RACH preambles including a RACH preamble corresponding to the first message and respective time-frequency resources of the one or more time-frequency resources include one or more TOs for the transmission of the third message within a time period. Additionally, or alternatively, the processor 1400 may be configured to or operable to support any one or combination of to receive semi-static signaling that indicates the one or more time-frequency resources and the first association is based on an ascending order of first indices associated with the one or more time-frequency resources and second indices associated with the one or more ROs. Additionally, or alternatively, the processor 1400 may be configured to or operable to support any one or combination of the first association is based on an ascending order of respective time periods associated with the one or more time-frequency resources and indices associated with respective RACH preambles of the set of RACH preambles where a duration of the respective time periods is based on a time window and the time window is based on a device type associated with the processor. Additionally, or alternatively, the processor 1400 may be configured to or operable to support any one or combination of the first association is based on an ascending order of first indices associated with the one or more time-frequency resources and second indices associated with respective RACH preambles of the set of RACH preambles. Additionally, or alternatively, the processor 1400 may be configured to or operable to support any one or combination of the first association is based on an ascending order of indices associated with the one or more ROs and respective time periods associated with the one or more time-frequency resources. Additionally, or alternatively, the processor 1400 may be configured to or operable to support any one or combination of the set of RACH preambles are associated with respective OCC sequence indices and the first association is based on an ascending order of the respective OCC sequence indices and indices associated with respective RACH preambles of the set of RACH preambles.

Additionally, or alternatively, the processor 1400 may be configured to or operable to support any one or combination of the to receive signaling that indicates an additional time-frequency resource associated with the third message based on a collision between the third message and an additional message and transmit the third message of the RACH procedure based on the additional time-frequency resource. Additionally, or alternatively, the processor 1400 may be configured to or operable to support any one or combination of the second message includes one or more of a RAPID associated with the first message, a timing advance, a temporary C-RNTI, or an index associated with the time-frequency resource. Additionally, or alternatively, to receive the second message, the processor 1400 may be configured to or operable to support any one or combination of to determine a third association between one or more ROs and one or more monitoring occasions associated with the second message. Additionally, or alternatively, the processor 1400 may be configured to or operable to support any one or combination of the time-frequency resource includes a CG resource.

The processor 1400 may be configured to or operable to support at least one controller (e.g., the controller 1402) coupled with at least one memory (e.g., the memory 1404) and configured to cause the processor to receive a first message of a RACH procedure, transmit, based on the first message, a second message of the RACH procedure, determine a time-frequency resource for reception of a third message of the RACH procedure based on at least one of a first association between the time-frequency resource and the second message or a second association between the time-frequency resource and the first message, and receive the third message of the RACH procedure based on the time-frequency resource.

Additionally, the processor 1400 may be configured to or operable to support any one or combination of to transmit a SIB that indicates one or more time-frequency resources including the time-frequency resource where the second message indicates the first association based on an index corresponding to the time-frequency resource from the one or more time-frequency resources. Additionally, or alternatively, the processor 1400 may be configured to or operable to support any one or combination of to transmit a SIB that indicates a first SSB-RSRP and transmit an SSB associated with a second SSB-RSRP where a numerical quantity of repetitions associated with the third message is based on comparing a difference between the first SSB-RSRP and the second SSB-RSRP to one or more SSB-RSRP threshold values. Additionally, or alternatively, the processor 1400 may be configured to or operable to support any one or combination of the first association is between one or more ROs and one or more time-frequency resources where the one or more ROs are associated with a set of RACH preambles including a RACH preamble corresponding to the first message and respective time-frequency resources of the one or more time-frequency resources include one or more TOs for transmission of the third message within a time period. Additionally, or alternatively, the processor 1400 may be configured to or operable to support any one or combination of to transmit semi-static signaling that indicates the one or more time-frequency resources and the first association is based on an ascending order of first indices associated with the one or more time-frequency resources and second indices associated with the one or more ROs. Additionally, or alternatively, the processor 1400 may be configured to or operable to support any one or combination of the first association is based on an ascending order of respective time periods associated with the one or more time-frequency resources and indices associated with respective RACH preambles of the set of RACH preambles where a duration of the respective time periods is based on a time window and the time window is based on a device type associated with a UE. Additionally, or alternatively, the processor 1400 may be configured to or operable to support any one or combination of the first association is based on an ascending order of first indices associated with the one or more time-frequency resources and second indices associated with respective RACH preambles of the set of RACH preambles. Additionally, or alternatively, the processor 1400 may be configured to or operable to support any one or combination of the first association is based on an ascending order of indices associated with the one or more ROs and respective time periods associated with the one or more time-frequency resources.

Additionally, or alternatively, the processor 1400 may be configured to or operable to support any one or combination of the set of RACH preambles are associated with respective OCC sequence indices and the first association is based on an ascending order of the respective OCC sequence indices and indices associated with respective RACH preambles of the set of RACH preambles. Additionally, or alternatively, the processor 1400 may be configured to or operable to support any one or combination of to determine a collision between the third message and an additional message based on one or more of a numerical quantity of random access preambles received, RAPIDs associated with the random access preambles, or cyclic demodulation reference signal DMRS configurations associated with an uplink shared channel corresponding to the third message, transmit signaling that indicates an additional time-frequency resource associated with the third message based on the collision between the third message and the additional message, and receive the third message of the RACH procedure based on the additional time-frequency resource. Additionally, or alternatively, the processor 1400 may be configured to or operable to support any one or combination of the second message includes one or more of a RAPID associated with the first message, a timing advance, a temporary C-RNTI, or an index associated with the time-frequency resource. The time-frequency resource includes a CG resource.

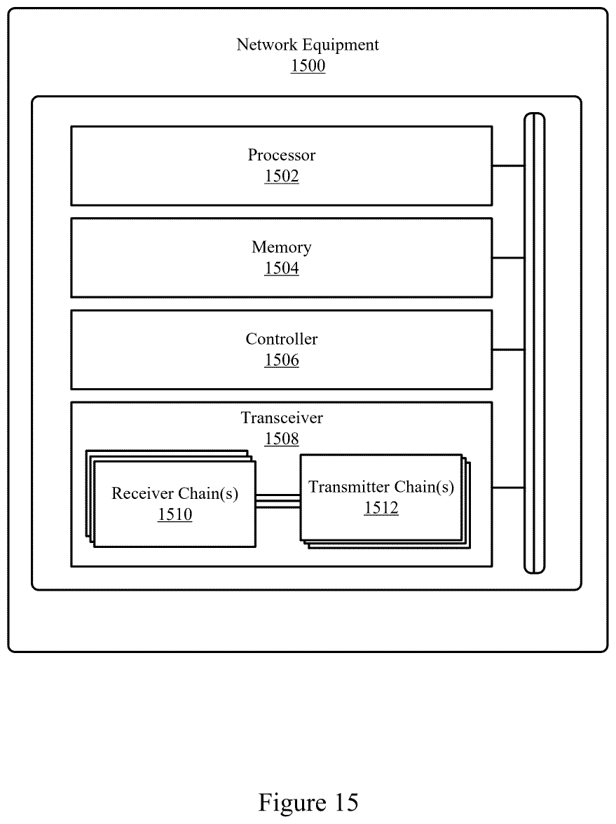

FIG. 15 illustrates an example of an NE 1500 in accordance with aspects of the present disclosure. The NE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the NE 1500 to perform various functions of the present disclosure.

The memory 1504 may include volatile or non-volatile memory. The memory 1504 may store computer-readable, computer-executable code including instructions when executed by the processor 1502 cause the NE 1500 to perform various functions described herein. The code may be stored in a non-transitory computer-readable medium such as the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the NE 1500 to perform one or more of the functions described herein (e.g., executing, by the processor 1502, instructions stored in the memory 1504). For example, the processor 1502 may support wireless communication at the NE 1500 in accordance with examples as disclosed herein. The NE 1500 may be configured to or operable to support a means for receiving a first message of a RACH procedure, transmitting, based on the first message, a second message of the RACH procedure, determining a time-frequency resource for reception of a third message of the RACH procedure based on at least one of a first association between the time-frequency resource and the second message or a second association between the time-frequency resource and the first message, and receiving the third message of the RACH procedure based on the time-frequency resource.

Additionally, the NE 1500 may be configured to or operable to support any one or combination of transmitting a SIB that indicates one or more time-frequency resources including the time-frequency resource, and the second message indicates the first association based on an index corresponding to the time-frequency resource from the one or more time-frequency resources. Additionally, or alternatively, the NE 1500 may be configured to or operable to support any one or combination of transmitting a SIB that indicates a first synchronization signal block SSB-reference signal received power RSRP, and transmitting an SSB associated with a second SSB-RSRP, where a numerical quantity of repetitions associated with the third message is based on comparing a difference between the first SSB-RSRP and the second SSB-RSRP to one or more SSB-RSRP threshold values. Additionally, or alternatively, the NE 1500 may be configured to or operable to support any one or combination of the first association is between one or more ROs and one or more time-frequency resources, the one or more ROs are associated with a set of RACH preambles including a RACH preamble corresponding to the first message, and respective time-frequency resources of the one or more time-frequency resources include one or more TOs for transmission of the third message within a time period. Additionally, or alternatively, the NE 1500 may be configured to or operable to support any one or combination of transmitting semi-static signaling that indicates the one or more time-frequency resources, and the first association is based on an ascending order of first indices associated with the one or more time-frequency resources and second indices associated with the one or more ROs. Additionally, or alternatively, the NE 1500 may be configured to or operable to support any one or combination of the first association is based on an ascending order of respective time periods associated with the one or more time-frequency resources and indices associated with respective RACH preambles of the set of RACH preambles, a duration of the respective time periods is based on a time window, and the time window is based on a device type associated with a UE. Additionally, or alternatively, the NE 1500 may be configured to or operable to support any one or combination of the first association is based on an ascending order of first indices associated with the one or more time-frequency resources and second indices associated with respective RACH preambles of the set of RACH preambles. Additionally, or alternatively, the NE 1500 may be configured to or operable to support any one or combination of the first association is based on an ascending order of indices associated with the one or more ROs and respective time periods associated with the one or more time-frequency resources.

Additionally, or alternatively, the NE 1500 may be configured to or operable to support any one or combination of the set of RACH preambles are associated with respective OCC sequence indices, and the first association is based on an ascending order of the respective OCC sequence indices and indices associated with respective RACH preambles of the set of RACH preambles. Additionally, or alternatively, the NE 1500 may be configured to or operable to support any one or combination of determining a collision between the third message and an additional message based on one or more of a numerical quantity of random access preambles received, RAPIDs associated with the random access preambles, or cyclic DMRS configurations associated with an uplink shared channel corresponding to the third message. Additionally, or alternatively, the NE 1500 may be configured to or operable to support any one or combination of transmitting signaling that indicates an additional time-frequency resource associated with the third message based on the collision between the third message and the additional message, and receiving the third message of the RACH procedure based on the additional time-frequency resource. Additionally, or alternatively, the NE 1500 may be configured to or operable to support any one or combination of the second message includes one or more of a RAPID associated with the first message, a timing advance, a temporary C-RNTI, or an index associated with the time-frequency resource. The time-frequency resource includes a CG resource.

Additionally, or alternatively, the NE 1500 may support at least one memory (e.g., the memory 1504) and at least one processor (e.g., the processor 1502) coupled with the at least one memory and configured to cause the NE to receive a first message of a RACH procedure, transmit, based on the first message, a second message of the RACH procedure, determine a time-frequency resource for reception of a third message of the RACH procedure based on at least one of a first association between the time-frequency resource and the second message or a second association between the time-frequency resource and the first message, and receive the third message of the RACH procedure based on the time-frequency resource.

Additionally, the NE 1500 may be configured to support any one or combination of to transmit a SIB that indicates one or more time-frequency resources including the time-frequency resource, and the second message indicates the first association based on an index corresponding to the time-frequency resource from the one or more time-frequency resources. Additionally, or alternatively, the NE 1500 may be configured to or operable to support any one or combination of to transmit a system information block SIB that indicates a first SSB-RSRP, and transmit an SSB associated with a second SSB-RSRP, where a numerical quantity of repetitions associated with the third message is based on comparing a difference between the first SSB-RSRP and the second SSB-RSRP to one or more SSB-RSRP threshold values. Additionally, or alternatively, the NE 1500 may be configured to or operable to support any one or combination of the first association is between one or more ROs and one or more time-frequency resources, the one or more ROs are associated with a set of RACH preambles including a RACH preamble corresponding to the first message, and respective time-frequency resources of the one or more time-frequency resources include one or more TOs for transmission of the third message within a time period. Additionally, or alternatively, the NE 1500 may be configured to or operable to support any one or combination of to transmit semi-static signaling that indicates the one or more time-frequency resources, and the first association is based on an ascending order of first indices associated with the one or more time-frequency resources and second indices associated with the one or more ROs. Additionally, or alternatively, the NE 1500 may be configured to or operable to support any one or combination of the first association is based on an ascending order of respective time periods associated with the one or more time-frequency resources and indices associated with respective RACH preambles of the set of RACH preambles, a duration of the respective time periods is based on a time window, and the time window is based on a device type associated with a UE. Additionally, or alternatively, the NE 1500 may be configured to or operable to support any one or combination of the first association is based on an ascending order of first indices associated with the one or more time-frequency resources and second indices associated with respective RACH preambles of the set of RACH preambles. Additionally, or alternatively, the NE 1500 may be configured to or operable to support any one or combination of the first association is based on an ascending order of indices associated with the one or more ROs and respective time periods associated with the one or more time-frequency resources.

Additionally, or alternatively, the NE 1500 may be configured to or operable to support any one or combination of the set of RACH preambles are associated with respective OCC sequence indices, and the first association is based on an ascending order of the respective OCC sequence indices and indices associated with respective RACH preambles of the set of RACH preambles. Additionally, or alternatively, the NE 1500 may be configured to or operable to support any one or combination of to determine a collision between the third message and an additional message based on one or more of a numerical quantity of random access preambles received, RAPIDs associated with the random access preambles, or cyclic demodulation reference signal DMRS configurations associated with an uplink shared channel corresponding to the third message. Additionally, or alternatively, the NE 1500 may be configured to or operable to support any one or combination of to transmit signaling that indicates an additional time-frequency resource associated with the third message based on the collision between the third message and the additional message, and receive the third message of the RACH procedure based on the additional time-frequency resource. Additionally, or alternatively, the NE 1500 may be configured to or operable to support any one or combination of the second message includes one or more of a RAPID associated with the first message, a timing advance, a temporary C-RNTI, or an index associated with the time-frequency resource. The time-frequency resource includes a CG resource.

The controller 1506 may manage input and output signals for the NE 1500. The controller 1506 may also manage peripherals not integrated into the NE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the NE 1500 may include at least one transceiver 1508. In some other implementations, the NE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas to receive a signal over the air or wireless medium. The receiver chain 1510 may include at least one amplifier (e.g., an LNA) configured to amplify the received signal. The receiver chain 1510 may include at least one demodulator configured to demodulate the receive signal and obtain the transmitted data by reversing the modulation technique applied during transmission of the signal. The receiver chain 1510 may include at least one decoder for decoding the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

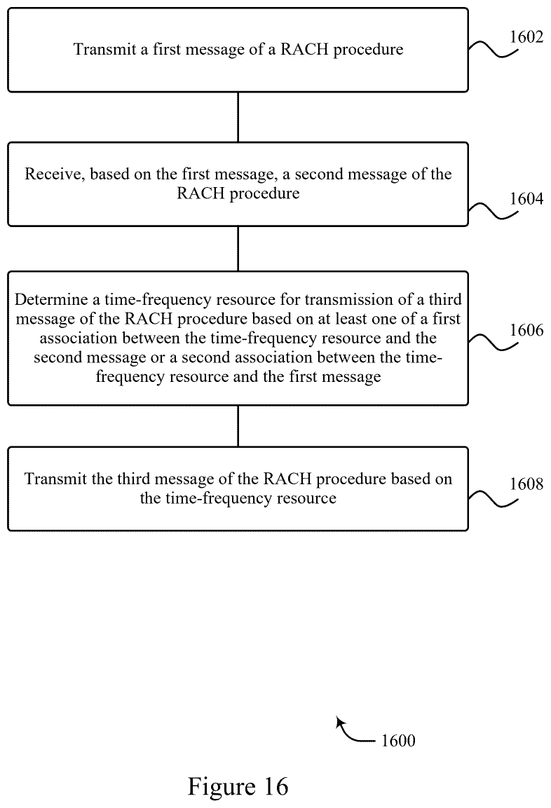

FIG. 16 illustrates a flowchart of a method 1600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1602, the method may include transmitting a first message of a RACH procedure. The operations of 1602 may be performed in accordance with examples as described herein. In some implementations, aspects of the operations of 1602 may be performed by a UE as described with reference to FIG. 13.

At 1604, the method may include receiving, based on the first message, a second message of the RACH procedure. The operations of 1604 may be performed in accordance with examples as described herein. In some implementations, aspects of the operations of 1604 may be performed by a UE as described with reference to FIG. 13.

At 1606, the method may include determining a time-frequency resource for transmission of a third message of the RACH procedure based on at least one of a first association between the time-frequency resource and the second message or a second association between the time-frequency resource and the first message. The operations of 1606 may be performed in accordance with examples as described herein. In some implementations, aspects of the operations of 1606 may be performed a UE as described with reference to FIG. 13.

At 1608, the method may include transmitting the third message of the RACH procedure based on the time-frequency resource. The operations of 1608 may be performed in accordance with examples as described herein. In some implementations, aspects of the operations of 1608 may be performed a UE as described with reference to FIG. 13.

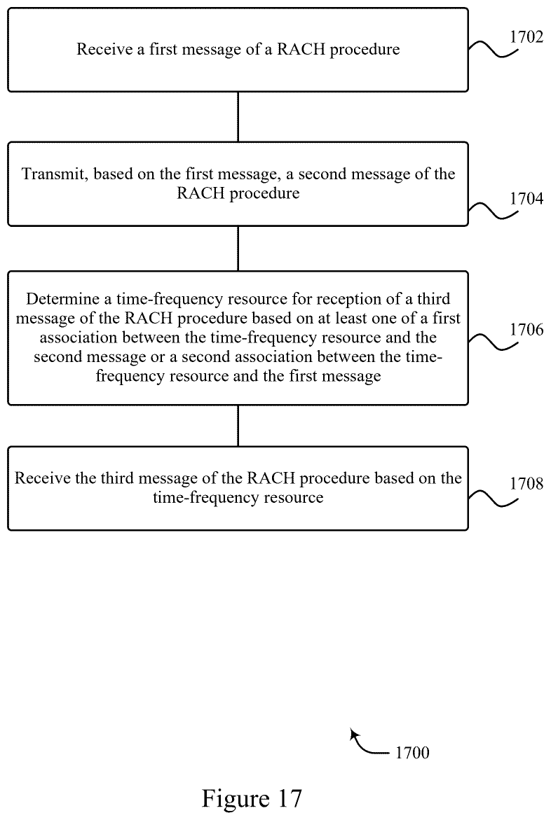

FIG. 17 illustrates a flowchart of a method 1700 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1702, the method may include receiving a first message of a RACH procedure. The operations of 1702 may be performed in accordance with examples as described herein. In some implementations, aspects of the operations of 1702 may be performed by an NE as described with reference to FIG. 15.

At 1704, the method may include transmitting, based on the first message, a second message of the RACH procedure. The operations of 1704 may be performed in accordance with examples as described herein. In some implementations, aspects of the operations of 1704 may be performed by an NE as described with reference to FIG. 15.

At 1706, the method may include determining a time-frequency resource for reception of a third message of the RACH procedure based on at least one of a first association between the time-frequency resource and the second message or a second association between the time-frequency resource and the first message. The operations of 1706 may be performed in accordance with examples as described herein. In some implementations, aspects of the operations of 1706 may be performed an NE as described with reference to FIG. 15.

At 1708, the method may include receiving the third message of the RACH procedure based on the time-frequency resource. The operations of 1708 may be performed in accordance with examples as described herein. In some implementations, aspects of the operations of 1708 may be performed an NE as described with reference to FIG. 15.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
transmit a first message of a random access channel (RACH) procedure;
receive, based at least in part on the first message, a second message of the RACH procedure;
determine a time-frequency resource for transmission of a third message of the RACH procedure based at least in part on at least one of a first association between the time-frequency resource and the second message or a second association between the time-frequency resource and the first message; and
transmit the third message of the RACH procedure based at least in part on the time-frequency resource.

2. The UE of claim 1, wherein to determine the time-frequency resource, the at least one processor is operable to cause the UE to receive a system information block (SIB) that indicates one or more time-frequency resources comprising the time-frequency resource.

3. The UE of claim 2, wherein the second message indicates the first association based at least in part on an index corresponding to the time-frequency resource from the one or more time-frequency resources, and wherein reception of the second message activates the time-frequency resource.

4. The UE of claim 2, wherein the second message fails to indicate an index associated with the time-frequency resource from the one or more time-frequency resources, wherein the at least one processor is further operable to cause the UE to select the time-frequency resource from the one or more time-frequency resources within a time window based at least in part on the first association, and wherein the time window is based at least in part on a device type associated with the UE.

5. The UE of claim 1, wherein the at least one processor is further operable to cause the UE to:
receive a system information block (SIB) that indicates a first synchronization signal block (SSB)-reference signal received power (RSRP);
receive an SSB associated with a second SSB-RSRP; and
select a numerical quantity of repetitions associated with the third message based at least in part on comparing a difference between the first SSB-RSRP and the second SSB-RSRP to one or more SSB-RSRP threshold values.

6. The UE of claim 1, wherein the first association is between one or more RACH occasions and one or more time-frequency resources, wherein the one or more RACH occasions are associated with a plurality of RACH preambles comprising a RACH preamble corresponding to the first message, and wherein respective time-frequency resources of the one or more time-frequency resources comprise one or more transmission occasions for the transmission of the third message within a time period.

7. The UE of claim 6, wherein the at least one processor is further operable to cause the UE to receive semi-static signaling that indicates the one or more time-frequency resources, and wherein the first association is based at least in part on an ascending order of first indices associated with the one or more time-frequency resources and second indices associated with the one or more RACH occasions.

8. The UE of claim 6, wherein the first association is based at least in part on an ascending order of respective time periods associated with the one or more time-frequency resources and indices associated with respective RACH preambles of the plurality of RACH preambles, wherein a duration of the respective time periods is based at least in part on a time window, and wherein the time window is based at least in part on a device type associated with the UE.

9. The UE of claim 6, wherein the first association is based at least in part on an ascending order of first indices associated with the one or more time-frequency resources and second indices associated with respective RACH preambles of the plurality of RACH preambles.

10. The UE of claim 6, wherein the first association is based at least in part on an ascending order of indices associated with the one or more RACH occasions and respective time periods associated with the one or more time-frequency resources.

11. The UE of claim 6, wherein the plurality of RACH preambles are associated with respective orthogonal cover code (OCC) sequence indices, and wherein the first association is based at least in part on an ascending order of the respective OCC sequence indices and indices associated with respective RACH preambles of the plurality of RACH preambles.

12. The UE of claim 1, wherein the at least one processor is further operable to cause the UE to:
receive signaling that indicates an additional time-frequency resource associated with the third message based at least in part on a collision between the third message and an additional message; and
transmit the third message of the RACH procedure based at least in part on the additional time-frequency resource.

13. The UE of claim 1, wherein the second message comprises one or more of a random access preamble identifier (RAPID) associated with the first message, a timing advance, a temporary cell-radio network temporary identifier (C-RNTI), or an index associated with the time-frequency resource.

14. The UE of claim 1, wherein to receive the second message, the at least one processor is operable to cause the UE to determine a third association between one or more RACH occasions and one or more monitoring occasions associated with the second message.

15. A method performed by a user equipment (UE), the method comprising:
transmitting a first message of a random access channel (RACH) procedure;
receiving, based at least in part on the first message, a second message of the RACH procedure;
determining a time-frequency resource for transmission of a third message of the RACH procedure based at least in part on at least one of a first association between the time-frequency resource and the second message or a second association between the time-frequency resource and the first message; and
transmitting the third message of the RACH procedure based at least in part on the time-frequency resource.

16. A network equipment (NE) for wireless communication, comprising:
at least one memory; and
at least one processor coupled with the at least one memory and operable to cause the NE to:
receive a first message of a random access channel (RACH) procedure;
transmit, based at least in part on the first message, a second message of the RACH procedure;
determine a time-frequency resource for reception of a third message of the RACH procedure based at least in part on at least one of a first association between the time-frequency resource and the second message or a second association between the time-frequency resource and the first message; and
receive the third message of the RACH procedure based at least in part on the time-frequency resource.

17. The NE of claim 16, wherein the at least one processor is further operable to cause the NE to transmit a system information block (SIB) that indicates one or more time-frequency resources comprising the time-frequency resource, wherein the second message indicates the first association based at least in part on an index corresponding to the time-frequency resource from the one or more time-frequency resources.

18. The NE of claim 16, wherein the at least one processor is further operable to cause the NE to:
transmit a system information block (SIB) that indicates a first synchronization signal block (SSB)-reference signal received power (RSRP); and
transmit an SSB associated with a second SSB-RSRP, wherein a numerical quantity of repetitions associated with the third message is based at least in part on comparing a difference between the first SSB-RSRP and the second SSB-RSRP to one or more SSB-RSRP threshold values.

19. The NE of claim 16, wherein the at least one processor is further operable to cause the NE to:
determine a collision between the third message and an additional message based at least in part on one or more of a numerical quantity of random access preambles received, random access preamble identifiers (RAPIDs) associated with the random access preambles, or cyclic demodulation reference signal (DMRS) configurations associated with an uplink shared channel corresponding to the third message;
transmit signaling that indicates an additional time-frequency resource associated with the third message based at least in part on the collision between the third message and the additional message; and
receive the third message of the RACH procedure based at least in part on the additional time-frequency resource.

20. A method performed by a network equipment (NE), the method comprising:
receiving a first message of a random access channel (RACH) procedure;
transmitting, based at least in part on the first message, a second message of the RACH procedure;
determining a time-frequency resource for reception of a third message of the RACH procedure based at least in part on at least one of a first association between the time-frequency resource and the second message or a second association between the time-frequency resource and the first message; and
receiving the third message of the RACH procedure based at least in part on the time-frequency resource.
